(19) United States
(12) Patent Application Publication
(10) Pub. No.: US 2008/0155111 A1
(43) Pub. Date: Jun. 26, 2008

(54) Delivery system, communication apparatus and delivery method

(75) Inventors: Tadashi Takeuchi, Sagamihara (JP); Aritoki Takada, Yokohama (JP)

Correspondence Address: MCDERMOTT WILL & EMERY LLP, 600 13TH STREET, N.W., WASHINGTON, DC, 20005-3096, US

(73) Assignee: HITACHI, LTD.

(21) Appl. No.: 12/003,116

(22) Filed: Dec. 20, 2007

(30) Foreign Application Priority Data
Dec. 20, 2006 (JP) 2006-342383

(51) Int. Cl. G06F 15/16

(52) U.S. Cl. 709/230

(57) ABSTRACT

A load on a delivery server can be reduced, irrespective of application protocol stack used by the delivery server.

The delivery server (110) transfers in advance a file object as a data body of content data from private storage (120) to a public storage of a storage system (130) through a storage network (181). The delivery server (110) sends a data container including an application protocol header to a router (160) through an IP network (180). The router (160) couples the application protocol header with the file object acquired from the public storage, and sends the couple to the client terminal (170).

### BACKGROUND OF THE INVENTION

The present invention relates to a technique of delivering content data such as a moving image to a client terminal through a network.

As a technique of reducing the load on a delivery server when the delivery server delivers large-volume data such as content data to a client terminal through a network, a method using a cache server is known (See Non-Patent Document 1, for example).

According to a method using a cache server, a cache server is placed between a client terminal and a delivery server, and an application protocol stack used by the delivery server, such as HyperText Transfer Protocol (HTTP) and Real Time Streaming Protocol (RTSP), for example, is installed in the cache server. Further, a part of contents held in an external storage of the delivery server has been previously copied to an external storage of the cache server.

The client terminal sends a delivery request to the cache server. Receiving the delivery request, the cache server activates the application protocol stack installed in the cache server, so that the cache server reads the content requested by the client terminal if the content in question exists in the external storage of the cache server. Then, the cache server delivers the content to the client terminal. On the other hand, if the content requested by the client terminal does not exist in the external storage of the cache server, the cache server sends the delivery request in question to the delivery server, and the delivery server delivers the content to the client terminal.

By employing this procedure, the delivery load is not applied to the delivery server when content stored in the external storage of the cache server is delivered, and load on the delivery server can be reduced.

Non-Patent Document 1: Network Appliance, Inc., “NetCache (registered trademark) 6.0 Deployment Guide”, pp. 168-171, November 2004

According to the conventional technique of using a cache server, it is required that an application protocol stack is installed in the cache server. In the case where a delivery server makes delivery by using an application protocol stack that is not supported by the cache server, the cache server cannot contribute to reduction of load on the delivery server.

Thus, an object of the present invention is to provide a technique that can reduce load on a delivery server regardless of an application protocol stack used by the delivery server.

### SUMMARY OF THE INVENTION

To solve the above problem, according to the present invention, a header area corresponding to an application protocol of the delivery server and content data are delivered separately. An apparatus arranged on a communication network between the delivery server and a client terminal couples the header area with the content data, and sends the couple to the client terminal.

For example, the present invention provides a delivery system for delivering content data to a client terminal through a network, wherein: the delivery system comprises a delivery server, a storage apparatus and a communication apparatus; and the communication apparatus receives header information specific to the content data from the delivery server, receives a data body of the content data from the storage apparatus, couples the header information with the data body of the content data, and sends the couple to the client terminal.

According to the present invention, a header area and content data are delivered separately, as described above. Thus, without depending on an application protocol stack used by a delivery server, the load on the delivery server can be reduced.

### BRIEF DESCRIPTION OF THE DRAWINGS

FIG. 1 is a schematic block diagram showing a delivery system as a first embodiment of the present invention;

FIG. 2 is a schematic block diagram showing a delivery server;

FIG. 3 is a schematic diagram showing a name management table;

FIG. 4 is a schematic diagram showing an ID management information table;

FIG. 5 is a schematic block diagram showing a private storage;

FIG. 6 is a schematic diagram showing a map management table;

FIG. 7 is a schematic block diagram showing a storage system;

FIG. 8 is a schematic diagram showing a public storage management table;

FIG. 9 is a schematic diagram showing a map management table;

FIG. 10 is a schematic block diagram showing a router;

FIG. 11 is a schematic diagram showing a sequence management table;

FIG. 12 is a schematic diagram showing a reception-waiting data list, an I/O-waiting data list and a send-waiting data list;

FIG. 13A is a schematic diagram showing a data container and FIG. 13B a schematic diagram showing TCP data;

FIG. 14 is a schematic block diagram showing a computer;

FIG. 15 is a schematic block diagram showing a computer;

FIG. 16 is a schematic block diagram showing a computer;

FIG. 17 is a flowchart showing general processing in the delivery system;

FIG. 18 is a flowchart showing processing of sending and receiving a storage area assignment request and a response to it between a delivery server and a domain server;

FIG. 19 is a flowchart showing processing of sending and receiving a file object duplication request and a response to it between a delivery server and a private storage;

FIG. 20 is a flowchart showing delayed copy;

FIG. 21 is a flowchart showing a file object transfer request and a response therefor between a delivery server and a private storage;

FIG. 22 is a flowchart showing processing of sending and receiving a connection request and a response therefor and a delivery request and a response therefor between a client terminal and a delivery server, and processing of sending and receiving TCP sequence state information between the delivery server and a router;

FIG. 23 is a flowchart showing processing of sending and receiving a data container between a delivery server and a router and processing of sending and receiving TCP data between a router and a client terminal;

FIG. 24 is a flowchart showing processing of sending and receiving a transmittal confirmation between a client terminal and a router and between the router and a delivery server;

FIG. 25 is a flowchart showing retransmit processing;

FIG. 26 is a schematic block diagram showing a delivery system;

FIG. 27 is a flowchart showing file object transfer processing;

FIG. 28 is a schematic block diagram showing a delivery system as a second embodiment of the present invention;

FIG. 29 is a schematic block diagram showing a delivery server;

FIG. 30 is a schematic block diagram showing a private storage;

FIG. 31 is a schematic block diagram showing a storage system;

FIG. 32 is a schematic block diagram showing a router;

FIG. 33 is a schematic diagram showing a duplication management table;

FIG. 34A is a schematic diagram showing duplication management information and FIG. 34B a schematic diagram showing UDP data;

FIG. 35 is a flowchart showing general processing in the delivery system;

FIG. 36 is a flowchart showing processing of sending and receiving a storage area assignment request between a delivery server and a domain server;

FIG. 37 is a flowchart showing processing of sending and receiving duplication management information between a delivery server and a router;

FIG. 38 is a flowchart showing processing of sending UDP data from a delivery server to a client terminal through a router;

FIG. 39 is a flowchart showing processing in which a delivery server obtains a send history file object from a public storage;

FIG. 40 is a schematic block diagram showing a delivery system as a third embodiment of the present invention;

FIG. 41 is a schematic block diagram showing a delivery server;

FIG. 42 is a schematic block diagram showing a private storage;

FIG. 43 is a schematic block diagram showing a storage system;

FIG. 44 is a schematic block diagram showing a router;

FIG. 45 is a schematic diagram showing an accumulation management table;

FIG. 46 is a schematic block diagram showing a client terminal;

FIG. 47 is a schematic diagram showing duplication management information;

FIG. 48 is a flowchart showing general processing in the delivery system;

FIG. 49 is a flowchart showing processing of sending accumulation management information from a client terminal to a router; and

FIG. 50 is a flowchart showing processing of sending UDP data from a delivery server to a client terminal.

### DETAILED DESCRIPTION

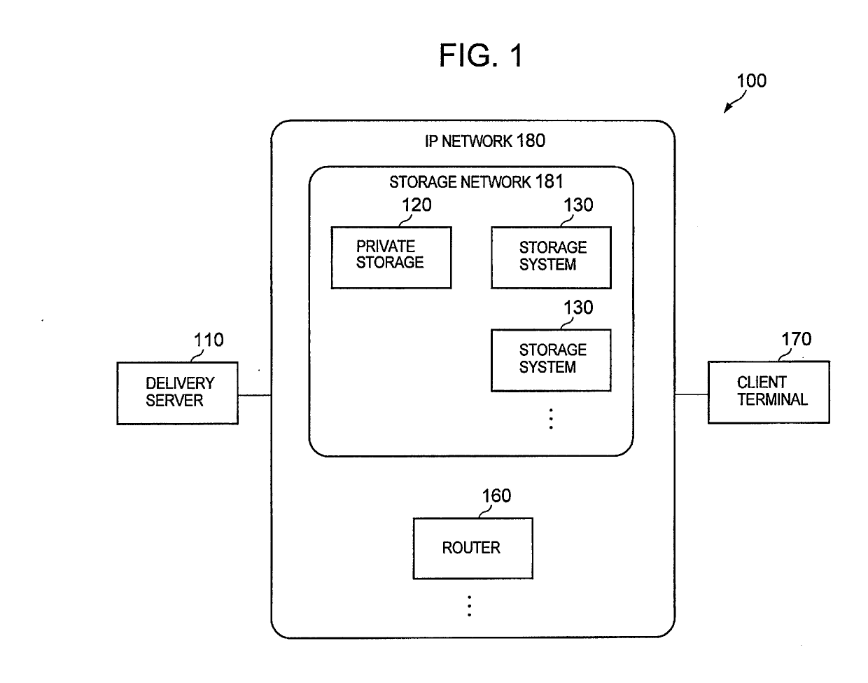

FIG. 1 is a schematic block diagram showing a delivery system 100 as a first embodiment of the present invention.

The delivery system 100 comprises a delivery server 110, a private storage 120, storage systems 130, a router 160, and a client terminal 170.

The delivery server 110 and the client terminal 170 can communicate with each other through an Internet Protocol (IP) network 180. The router 160 is arranged in the IP network 180.

Further, a storage network 181 is provided in the IP network 180. The private storage 120 and the storage systems 130, which are provided in the storage network 181, can communicate with one another within the storage network 181. Further, these private storage 120 and storage systems 130 can communicate with the delivery server 110, the router 160 and the client terminal 170 through the IP network 180.

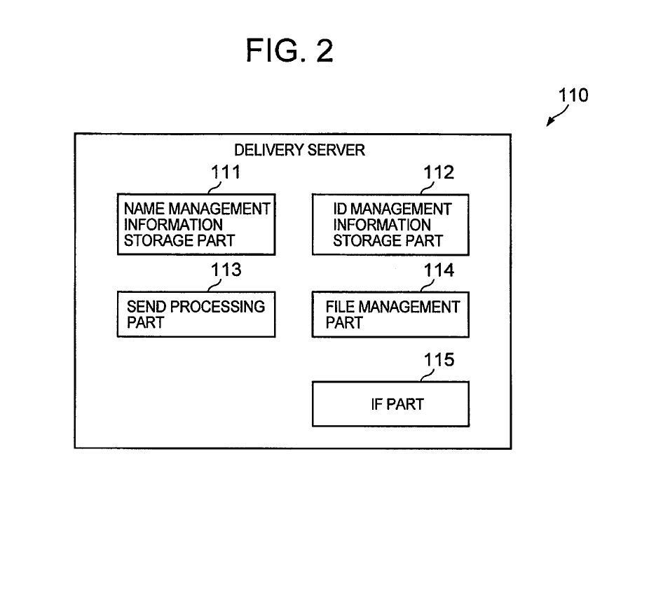

FIG. 2 is a schematic block diagram showing the delivery server 110.

As shown in the figure, the delivery server 110 comprises a name management information storage part 111, an ID management information storage part 112, a send processing part 113, a file management part 114 and an IF part 115.

The name management information storage part 111 stores information that specifies: a path name; and information (an object ID) identifying a file object corresponding to that path name.

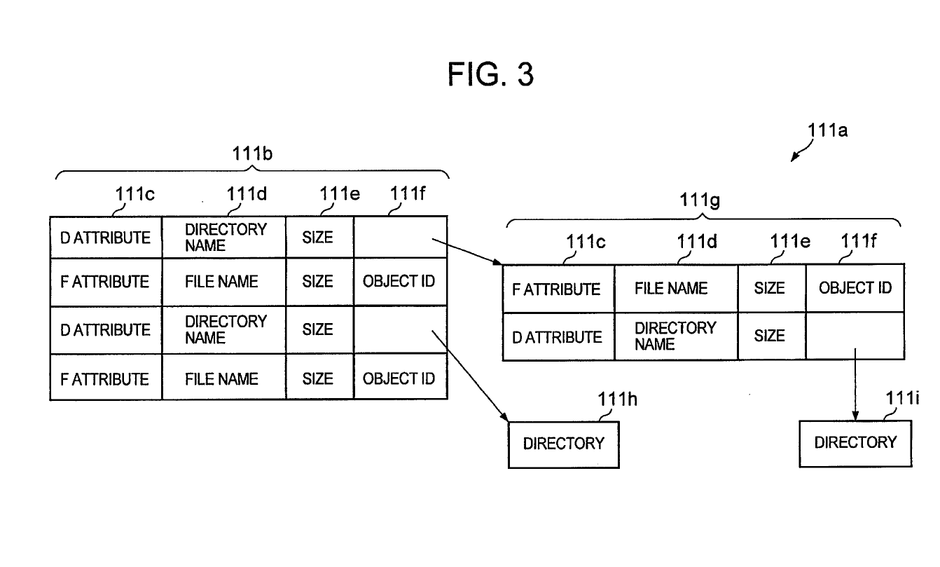

For example, in the present embodiment, the name management information storage part 111 stores a name management table 111a as shown in FIG. 3 (a schematic diagram showing the name management table 111a).

As shown in the figure, the name management table 111a has a root directory 111b at a predetermined address, and the root directory 111b and lower directories 111g, 111h and 111i each have an attribute field 111c, a name field 111d, a size field 111e and an object ID field 111f.

The attribute field 111c stores information indicating whether the entry in question is a directory or a file.

The name field 111d stores information indicating the name of the entry, i.e. a directory name or a file name.

When the attribute of the entry is “file”, the size field 111e stores a data size of the file. On the other hand, when the attribute of the entry is “directory”, the size field 111e stores a value such as “0”, for example.

When the attribute of the entry is “file”, the object ID field 111f stores information specifying identification information (object ID) by which the file having the corresponding path name is registered in the below-described private storage 120. On the other hand, when the attribute of the entry is “directory”, the object ID field 111f stores information specifying at which address the directory having the corresponding path name is stored.

By following the name management table 111a from the root directory 111b, the below-described file management part 114 can specify as which object ID a file corresponding to a given path name is stored in the private storage 120.

Here, in the present embodiment, identification information of a file previously stored in the private storage 120 is referred to as an object ID₁, and identification information of a file duplicated in the private storage 120 as described below as an object ID₂.

Returning to FIG. 2, the ID management information storage part 112 stores information that specifies: a path name; identification information of a file from which the file corresponding to that path name has been duplicated; address information of a public storage 150 that stores the file corresponding to that path name; and additional information (header information) added to the file corresponding to that path name.

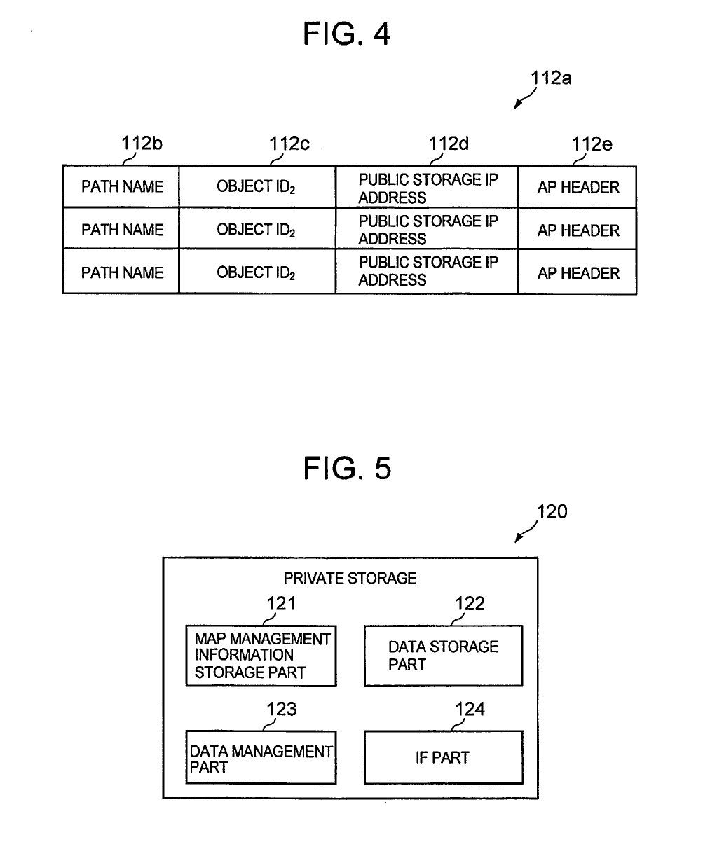

For example, in the present embodiment, the ID management information storage part 112 stores an ID management information table 112a as shown in FIG. 4 (a schematic diagram showing the ID management information table 112a).

As shown in the figure, the ID management information table 112a has a path name field 112b, an object ID field 112c, a public storage IP address field 112d, and an AP header field 112e.

The path name field 112b stores a path name of a file.

The object ID field 112c stores an object ID₂, i.e. identification information at the time of duplicating the file corresponding to the path name specified in the path name field 112b, in the below-described private storage 120.

The public storage IP address field 112d stores an IP address of a public storage 150 to which the file corresponding to the path name specified in the path name field 112b is transferred and stored therein.

The AP header field 112e stores an application header of the file corresponding to the path name specified in the path name field 112b.

Returning to FIG. 2, the send processing part 113 controls processing of delivering a file object stored in the private storage 120, in response to a connection request and a delivery request from the client terminal 170.

Here, in the present embodiment, a file object means basic data without header information.

Particularly in the present embodiment, the send processing part 113 issues a storage area assignment request and an assignment continuation request to a domain server 140 in order to reserve an area of a certain size in the public storage 150.

Further, through the file management part 114, the send processing part 113 requests the private storage 120 to duplicate a file object and to transfer the duplicated file object to the public storage 150.

Further, the send processing part 113 sends sequence number information for specifying a sequence number in response to a connection request and a delivery request from the client terminal 170, and thereafter, sends a data container to the router 160.

Here, the data container includes at least information specifying additional information (header information) added to the file object and information specifying the address of the public storage 150 that stores the file object.

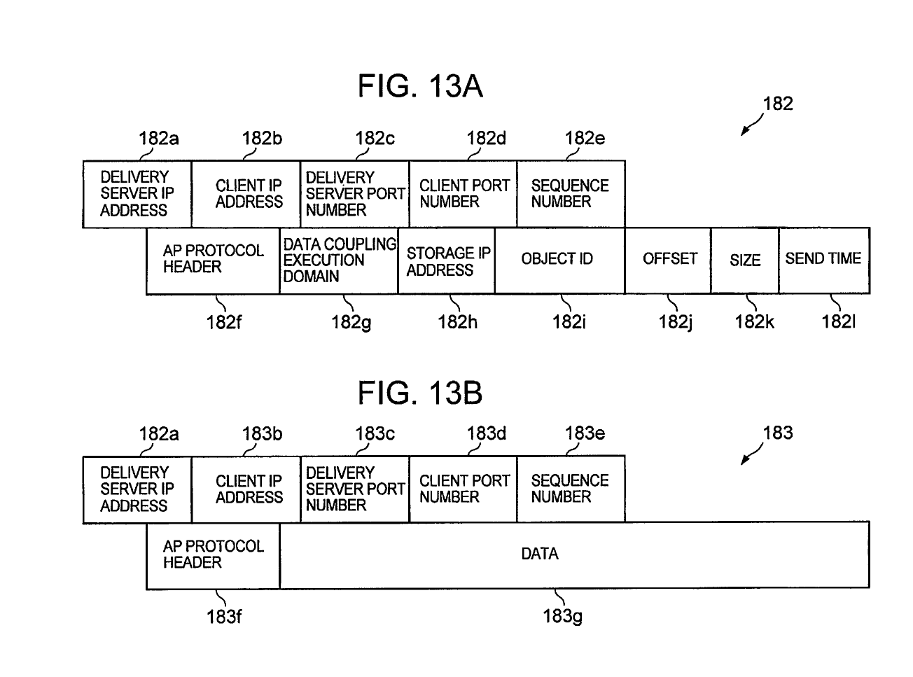

For example, in the present embodiment, a data container 182 as shown in FIG. 13A is sent to the router 160.

As shown in the figure, a data container 182 has a delivery server IP address storage area 182a, a client IP address storage area 182b, a delivery server port number storage area 182c, a client port number storage area 182d, a sequence number storage area 182e, an AP protocol header storage area 182f, a data coupling execution domain storage area 182g, a storage IP address storage area 182h, an object ID storage area 182i, an offset storage area 182j, a size storage area 182k, and a send time storage area 182l. Information to be stored in these areas will be described below.

Returning to FIG. 2, the file management part 114 manages information to be stored in the name management information storage part 111 and the ID management information storage part 112.

Particularly in the present embodiment, when the file management part 114 receives a file object duplication request designating a path name from the send processing part 113, then the file management part 114 specifies an object ID₁ of a file object corresponding to the path name and sends a duplicate request designating the object ID₁ to the private storage 120.

Then, the file management part 114 receives an object ID₂ of a duplicated file object from the private storage 120, and stores the object ID₂ in connection with the path name in the ID management information table 112a.

Further, in reply to an inquiry designating a path name from the send processing part 113, the file management part 114 sends the object ID₂ that is stored in connection with the path name in question in the ID management information table 112a.

The IF part 115 is an interface for sending and receiving information through the IP network 180.

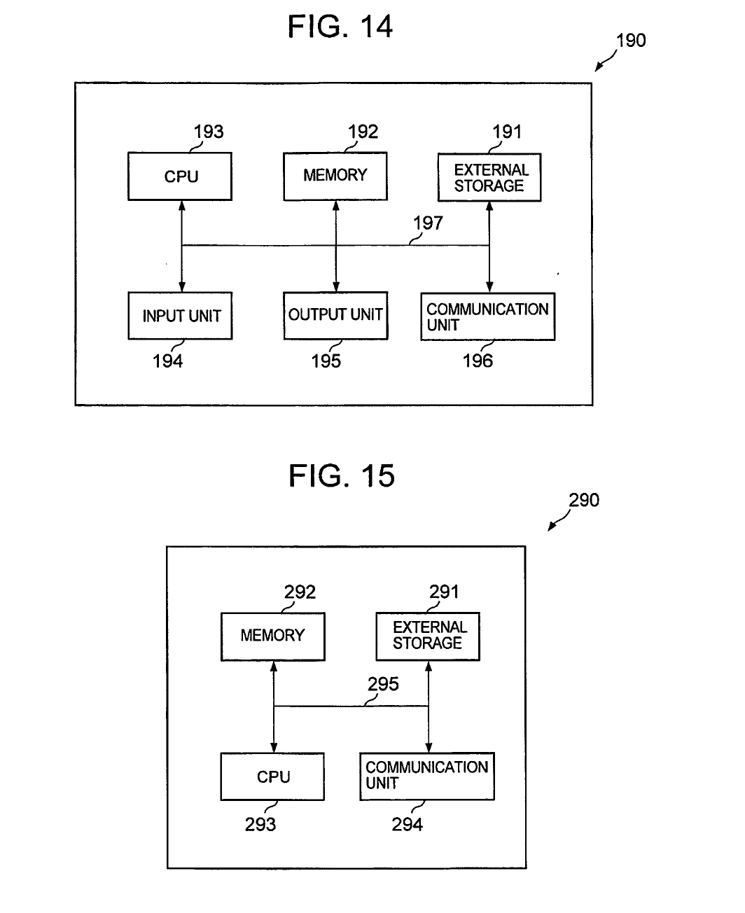

Here, the delivery server 110 can be implemented by a computer 190 as shown in FIG. 14.

The computer 190 comprises an external storage 191 such as a hard disk, a memory 192, a Central Processing Unit (CPU) 193, an input unit 194 such as a keyboard or a mouse, an output unit 195 such as a display or a printer, a communication unit 196 such as a Network Interface Card (NIC), and a bus 197 connecting the mentioned components. For example, the name management information storage part 111 and the ID management information storage part 112 can be implemented by the external storage 191. The send processing part 113 and the file management part 114 can be implemented when prescribed programs stored in the external storage 191 are loaded into the memory 192 and executed by the CPU 193. The IF part 115 can be implemented by the communication unit 196.

FIG. 5 is a schematic diagram showing the private storage 120.

As shown in the figure, the private storage 120 comprises a map management information storage part 121, a data storage part 122, a data management part 123, and an IF part 124.

The map management information storage part 121 stores at least identification information for identifying a file object and information specifying the storage location of the file object, for each file object stored in the data storage part 122.

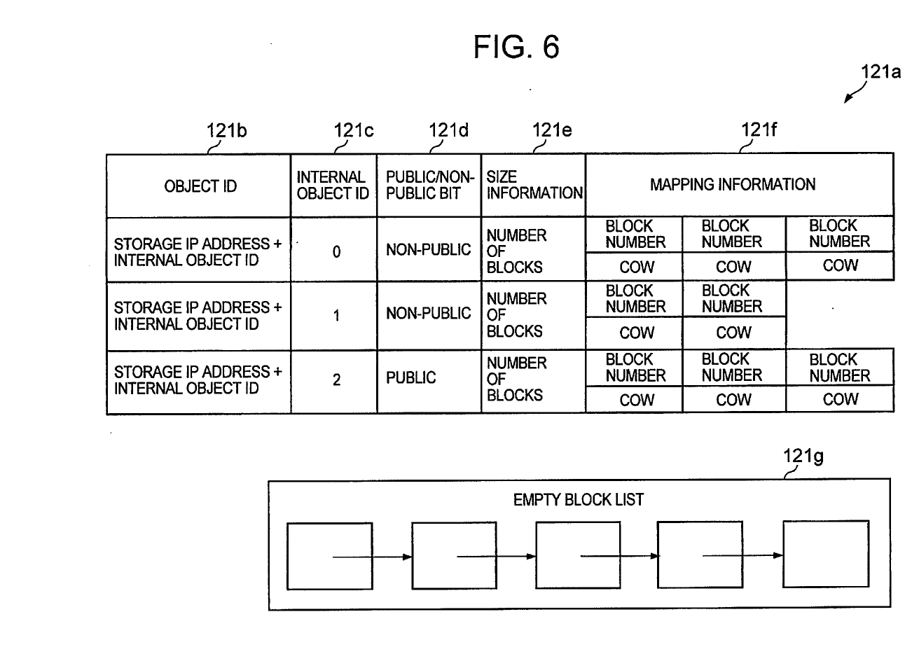

For example, in the present embodiment, the map management information storage part 121 stores a map management table 121a as shown in FIG. 6 (a schematic diagram showing the map management table 121a).

As shown in the figure, the map management table 121a has an object ID field 121b, an internal object ID field 121c, a public/non-public bit field 121d, a size information field 121e, a mapping information field 121f and an free block list field 121g.

The object ID field 121b stores information for identifying a file object corresponding to the entry in question.

Here, in the present embodiment, an object ID for identifying a file object corresponding to content data previously stored in the private storage 120 is referred to as an object ID₁, and an object ID for identifying a new file object generated when a duplicate of a file object specified by an object ID₁ is generated in accordance with an instruction of the file management part 114 of the delivery server 110 is referred to as an object ID₂.

The internal object ID field 121c stores information for identifying the file object corresponding to the entry in question.

Here, in the present embodiment, each time a new file to be stored in the data storage part 122 of the private storage 120 is generated, the data management part 123 generates identification information (ID) of the newly-generated file and stores the generated ID in the internal object ID field 121c.

In order to be able to know which file object is stored in the private storage 120, a unique identification information (ID) stored in the object ID field 121b is generated by combining the IP address of the private storage 120 in question with the identification information (ID) to be stored in the internal object ID field 121c.

The public/non-public bit field 121d stores information specifying whether the file object of the entry in question is opened to the public or not.

With respect to a file object designated as non-public in this field 121d, a read request, a write request, a duplication request and a transfer request are received only from a specific delivery server 110. On the other hand, with respect to a file object designated as public in this field 121d, a read request, a write request and a transfer request are received from any delivery server 110 or any router 160.

The size information field 121e stores information specifying the data size of the file object of the entry in question. In the present embodiment, the size information field 121e stores the number of blocks.

The mapping information field 121f stores information specifying the location in the data storage part 122, at which the file object of the entry in question is stored. In the present embodiment, the mapping information field 121f stores block numbers of blocks in the data storage part 122.

Here, in the present embodiment, the mapping information field 121f stores not only block numbers but also Copy On Write (COW) bits so that a virtual copy of the file object can be realized as described below.

The free block list field 121g stores information (a list) that specifies empty blocks in the data storage part 122 of the private storage 120.

The data storage part 122 stores file objects.

The data management part 123 manages data stored in the map management information storage part 121 and data stored in the data storage part 122.

The IF part 124 is an interface for sending and receiving information through the IP network 180 and the storage network 181.

The above-described private storage 120 can be implemented by a computer 290 as shown in FIG. 15.

The computer 290 comprises an external storage 291 such as a hard disk, a memory 292, a CPU 293, a communication unit 294 such as an NIC, and a bus 295 connecting the mentioned components. For example, the map management information storage part 121 and the data storage part 122 can be implemented by the external storage 291. The data management part 123 can be implemented when prescribed programs stored in the external storage 291 are loaded into the memory 292 and executed by the CPU 293. The IF part 124 can be implemented by the communication unit 294.

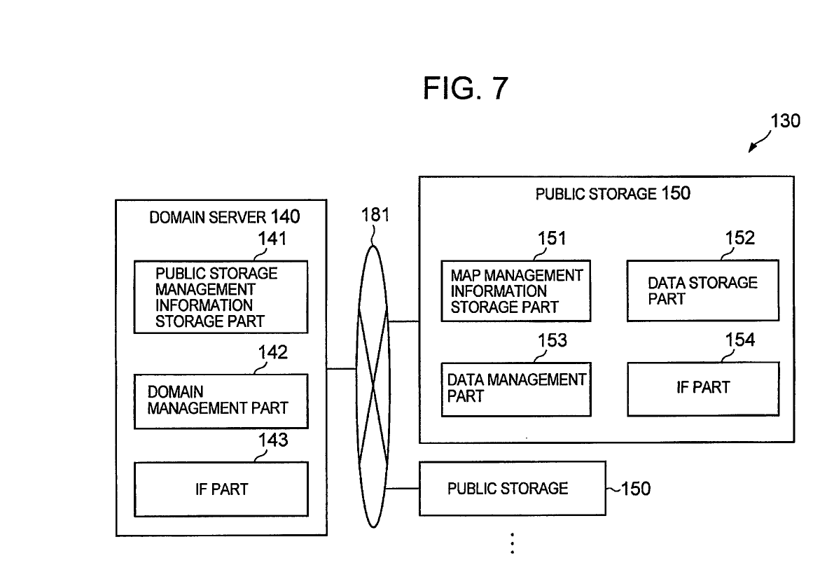

FIG. 7 is a schematic block diagram showing a storage system 130.

As shown in the figure, a storage system 130 comprises a domain server 140 and one or more public storages 150. The domain server 140 and the public storages 150 can send and receive information to and from one another through the storage network 181.

The domain server 140 comprises a public storage management information storage part 141, a domain management part 142 and an IF part 143. The domain server 140 is a server for managing the public storages 150 arranged in the domain of the domain server 140.

The public storage management information storage part 141 stores information for specifying file objects stored in the public storages 150 managed by the domain server 140.

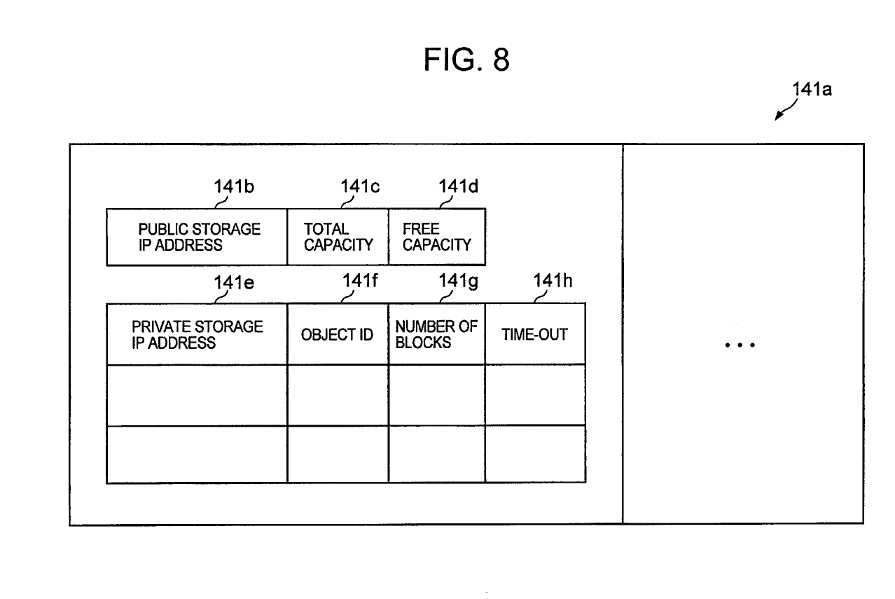

For example, in the present embodiment, the public storage information storage part 141 stores a public storage management table 141a as shown in FIG. 8 (a schematic diagram showing the public storage management table 141a).

As shown in the figure, a public storage management table 141a has a public storage IP address field 141b, a total capacity field 141c, a free capacity field 141d, a private storage IP address field 141e, an object ID field 141f, a number-of-blocks field 141g, and a time-out field 141h. A public storage management table 141a is generated for each public storage managed by the domain server 140.

The public storage IP address field 141b stores the IP address of a public storage 150 managed by the domain server 140.

The total capacity field 141c stores the total storage capacity assigned for storing file objects in the public storage 150 specified in the public storage IP address field 141b.

The free capacity field 141d stores free capacity out of the total storage capacity assigned for storing file objects in the public storage 150 specified in the public storage IP address field 141b.

The private storage IP address field 141e stores the IP address of the private storage 120 as a sender of a file object stored in the public storage 150 specified in the public storage IP address field 141b.

The object ID field 141f stores identification information for specifying a file object stored in the public storage 150 specified in the public storage IP address field 141b.

Here, in the present embodiment, the object ID field 141f stores an object ID₁ included in an assignment request from the delivery server 110.

The number-of-blocks field 141g stores the number of blocks assigned for storing a file object in the public storage 150 specified in the public storage IP address field 141b.

Here, in the present embodiment, the number of blocks, which is included in an assignment request from the delivery server 110, is stored in the number-of-blocks field 141g.

The time-out field 141h stores a time-out value for reservation of an area assigned for storing a file object in the public storage 150 specified in the public storage IP address field 141b. By managing such a time-out value, it is possible to free the area in question forcedly when an assignment continuation request for the area does not arrive from the delivery server 110 within a prescribed time (for example, owing to failure of the delivery server 110).

Returning to FIG. 7, the domain management part 142 controls general processing in the domain server 140. In particular, in the present embodiment, the domain management part 142 manages information stored in the public storage management information storage part 141.

The IF part 143 is an interface for sending and receiving information through the IP network 180 and the storage network 181.

The domain server 140 also can be implemented by a computer 190 as shown in FIG. 14.

For example, the public storage management information storage part 141 can be implemented by the external storage 191. The domain management part 142 can be implemented when prescribed programs stored in the external storage 191 are loaded into the memory 192 and executed by the CPU 193. The IF part 143 can be implemented by the communication unit 196.

Returning to FIG. 7, each public storage 150 comprises a map management information storage part 151, a data storage part 152, a data management part 513 and an IF part 154.

The map management information storage part 151 stores at least identification information for identifying a file object and information indicating the storage location of the file object, for each file object stored in the data storage part 152.

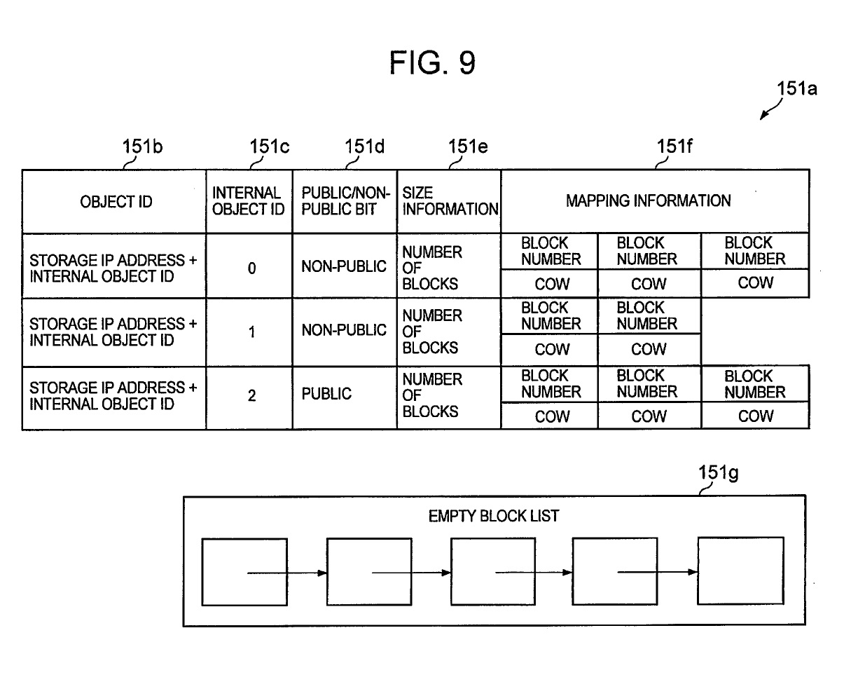

For example, in the present embodiment, the map management information storage part 151 stores a map management table 151a as shown in FIG. 9 (a schematic diagram showing the map management table 151a).

As shown in the figure, the map management table 151a has an object ID field 151b, an internal object ID field 151c, a public/non-public bit field 151d, a size information field 151e, a mapping information field 151f and an free block list field 151g.

The object ID field 151b stores information for identifying a file object corresponding to the entry in question.

Here, in the present embodiment, the object ID field 151b stores an object ID₂ for identifying a file object corresponding to content data sent from the private storage 120.

The internal object ID field 151c stores information for identifying the file object corresponding to the entry in question.

Here, in the present embodiment, each time a new file to be stored in the data storage part 152 of the public storage 150 is generated, the data management part 153 generates identification information (ID) of the newly-generated file and stores the generated ID in the internal object ID field 151c.

The public/non-public bit field 151d stores information specifying whether the file object corresponding to the entry in question is opened to the public or not.

With respect to a file object designated as non-public in this field 151d, a read request, a write request, a duplication request and a transfer request are received only from a specific delivery server 110. On the other hand, with respect to a file object designated as public in this field 151d, a read request, a write request and a transfer request are received from any delivery server 110 or any router 160.

The size information field 151e stores information specifying the data size of the file object corresponding to the entry in question. In the present embodiment, the size information field 151e stores the number of blocks.

The mapping information field 151f stores information specifying the location in the data storage part 152, at which the file object of the entry in question is stored. In the present embodiment, the mapping information field 151f stores block numbers of blocks in the data storage part 152.

Here, in the present embodiment, the mapping information field 151f stores not only block numbers but also Copy On Write (COW) bits so that virtual copy of the file object can be realized as described later.

The free block list field 151g stores information (a list) that specifies empty blocks in the data storage part 152 of the public storage 150.

The data storage part 152 stores file objects.

The data management part 153 manages data stored in the map management information storage part 151 and data stored in the data storage part 152.

The IF part 154 is an interface for sending and receiving information through the IP network 180 and the storage network 181.

The above-described public storage 150 also can be implemented by a computer 290 as shown in FIG. 15.

For example, the map management information storage part 151 and the data storage part 152 can be implemented by the external storage 291. The data management part 153 can be implemented when prescribed programs stored in the external storage 291 are loaded into the memory 292 and executed by the CPU 293. The IF part 154 can be implemented by the communication unit 294.

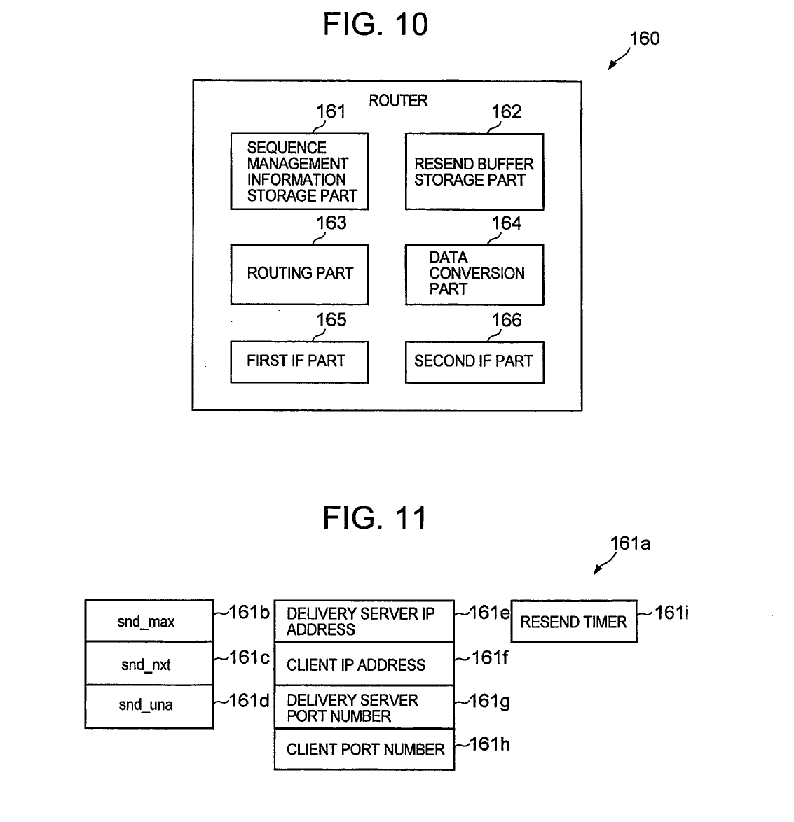

FIG. 10 is a schematic diagram showing the router 160.

As shown in the figure, the router 160 comprises a sequence management information storage part 161, a retransmit buffer storage part 162, a routing part 163, a data conversion part 164, a first IF part 165 and a second IF part 166.

The sequence management information storage part 161 stores sequence information for specifying to what position a data stream has been sent or received, for each connection established between the delivery server 110 and the client terminal 170.

For example, in the present embodiment, the sequence management information storage part 161 stores a sequence management table 161a as shown in FIG. 11 (a schematic diagram showing the sequence management table 161a) for each connection established between the delivery server 110 and the client terminal 170.

As shown in the figure, the sequence management table 161a has an snd_max field 161b, an snd_nxt field 161c, an snd_una field 161d, a delivery server IP address field 161e, a client IP address field 161f, a delivery server port number field 161g, a client port number field 161h and a retransmit timer field 161i.

The snd_max field 161b stores the maximum value of the sequence number of TCP data sent from the router 160 to the client terminal 170 (i.e. the initial value of the sequence number+the data size of the sent TCP data), at the current point of time (specific point of time).

The snd_nxt field 161c stores the sequence number of TCP data to be sent next from the router 160 to the client terminal 170, at the current point of time (specific point of time).

The snd_una field 161d stores the maximum value of the sequence number included in a transmittal confirmation that has arrived at the router 160 from the client terminal 170 (i.e. the initial value of the sequence number+the data size of TCP data of which transmittal confirmations have arrived) until the current point of time (specific point of time).

The delivery server IP address field 161e stores the IP address of the connected delivery server 110.

The client IP address field 161f stores the IP address of the connected client terminal 170.

The delivery server port number field 161g stores the port number of the connected delivery server 110.

The client port number field 161h stores the port number of the connected client terminal 170.

The retransmit timer field 161i stores the counter value of a retransmit timer used for retransmitting TCP data from the router 160 to the client terminal 170.

The retransmit buffer storage part 162 stores data to be sent in a data stream, for each connection established between the delivery server 110 and the client terminal 170.

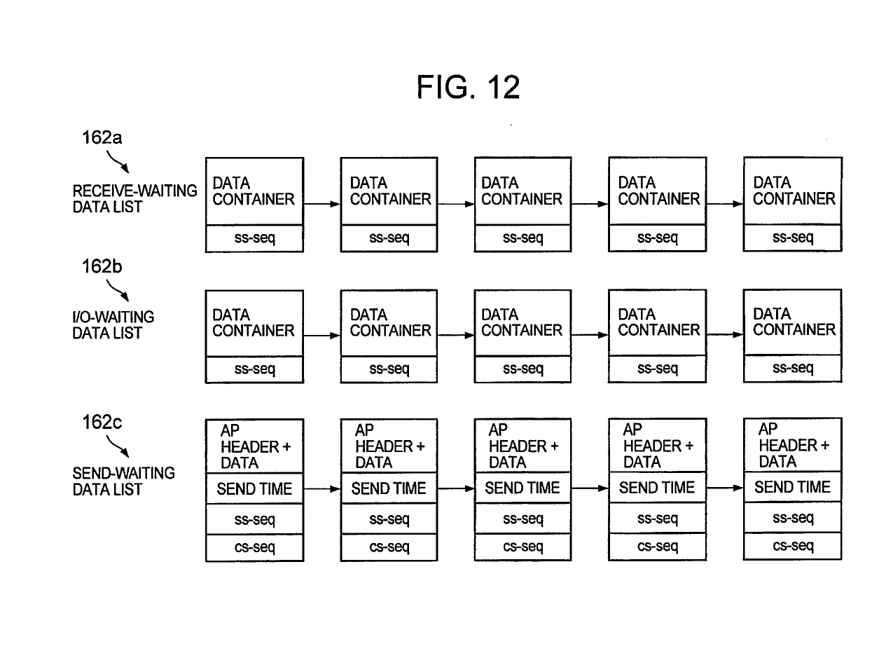

For example, in the present embodiment, the retransmit buffer storage part 162 stores a reception-waiting data list 162a, an I/O-waiting data list 162b and a send-waiting data list 162c as shown in FIG. 12 (a schematic diagram showing the reception-waiting data list 162a, the I/O-waiting data list 162b and the send-waiting data list 162c) for each connection between the delivery server 110 and the client terminal 170.

The reception-waiting data list 162a is a data structure for queuing data containers that the router 160 has received from the delivery server 110.

As described below, data containers sent from the delivery server 110 are assigned sequence numbers. When, however, a part or all of data are lost before arrival of the data containers at the router 160 from the delivery server 110, the delivery server 110 retransmits the portion of data that were lost. Until the data to be resent arrive, data that have not been lost are queued in the reception-waiting data list 162a.

The reception-waiting data list 162a stores not only data containers received by the router 160 but also sequence numbers (each expressed as ss-seq) sent together with the respective data containers when the data containers are sent from the send processing part 113 of the delivery server 110.

The I/O-waiting data list 162b is a data structure for queuing data containers corresponding to a file object while the file object is being read from the public storage 150 on the basis of information of the IP address of the public storage 150, the object ID₂, the offset and the size stored in the data containers received from the delivery server 110.

Also the I/O-waiting data list 162b stores not only data containers received by the router 160 but also sequence numbers (each expressed as ss-seq) sent together with the respective containers when the data containers are sent from the send processing part 113 of the delivery server 110.

The send-waiting data list 162c is a data structure for queuing combinations (TCP data) of a file object read from the public storage 150 and an application protocol header.

It is necessary to retransmit TCP data from the router 160 when the TCP data are lost between the router 160 and the client terminal 170. To prepare for retransmitting, the TCP data are queued in the send-waiting data list 162c until a transmittal confirmation of the TCP data arrives from the client terminal 170. The send-waiting data list 162c stores not only combinations of an application protocol header and data (a file object) but also respective pieces of send time information and sequence numbers (each expressed as ss-seq). Further, the send-waiting data list 162c stores sequence numbers (each expressed as cs-seq) used for sending the respective pieces of TCP data from the router 160 to the client terminal 170.

The routing part 163 controls so-called routing for transferring packets received from the below-described first or second IF part 165, 166.

The data conversion part 164 controls processing of extracting an application header from a data container received from the delivery server 110, generating TCP data by adding the application header to a file object received from the public storage 150, and sending the generated TCP data to the client terminal 170 through the second IF part 166.

Here, it is sufficient that TCP data have at least an application header storage area and a file object storage area.

For example, in the present embodiment, TCP data 183 as shown in FIG. 13B are generated.

As shown in the figure, TCP data 183 has a delivery server IP address storage area 183a, a client IP address storage area 183b, a delivery server port number storage area 183c, a client port number storage area 183d, a sequence number storage area 183e, an AP protocol storage area 183f, and a data storage area 183g. Information to be stored in each area will be described later.

Further, the data conversion part 164 controls processing of sequence number conversion between the delivery server 110 and the client terminal 170.

The first IF part 165 and the second IF part 166 are interfaces for sending and receiving data through the IP network 180.

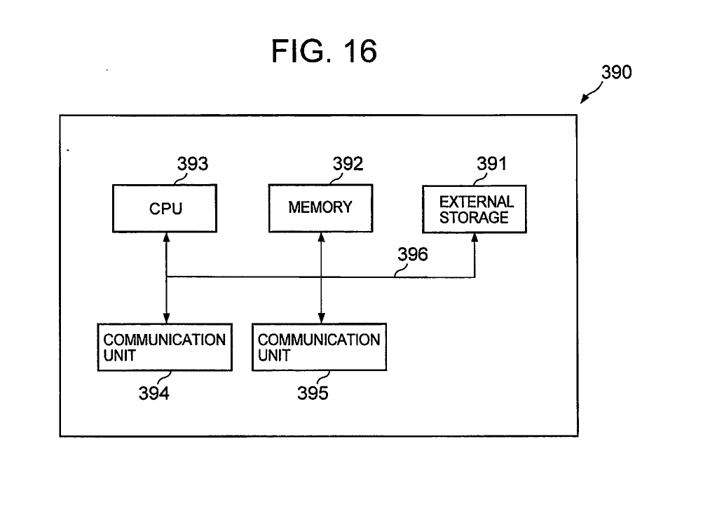

The router 160 can be implemented by a computer 390 as shown in FIG. 16.

The computer 390 comprises an external storage 391 such as a hard disk, a memory 392, a CPU 393, communication units 394, 395 such as NICs, and a bus 396 connecting the described components. For example, the sequence management information storage part 161 and the retransmit buffer storage part 162 can be implemented by the external storage 391. The routing part 163 and the data conversion part 164 can be implemented when prescribed programs stored in the external storage 391 are loaded into the memory 392 and executed by the CPU 394. The first IF part 165 can be implemented by the communication unit 394, and the second IF part 166 by the communication unit 395.

The client terminal 170 sends a connection request and a delivery request to the delivery server 110, receives TCP data and returns a transmission confirmation when it receives TCP data. As the client terminal 170, a computer that can communicate through IP, can be used, such as conventionally-used computer, and a detailed description thereof will be omitted.

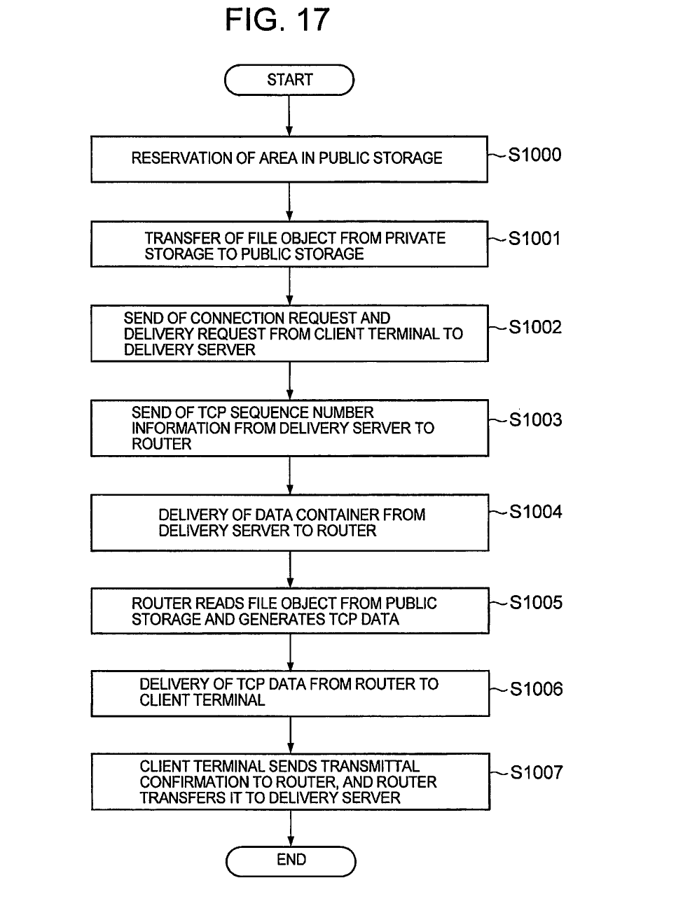

General processing in the delivery system 100 of the above-described configuration will be described referring to the flowchart shown in FIG. 17.

It is assumed that the data storage part 122 of the private storage 120 previously stores a file object corresponding to content data sent from the delivery server 110 to the client terminal, and identification information of the file object is an object ID₁.

First, the send processing part 113 of the delivery server 110 issues a storage area assignment request (and thereafter, assignment continuation requests at regular time intervals) to the domain server 140 through the IF part 115, to reserve an area of a certain size in the data storage part 152 of the public storage 150 (S1000). Then, the domain server 140 updates information stored in the public storage management table 141a stored in the public storage management information storage part 141.

Next, through the file management part 114, the send processing part 113 of the delivery server 110 requests the private storage 120 to duplicate a file object designated by a path and to transfer the duplicated file object to the public storage 150. Here, the file management part 114 derives the object ID₁ corresponding to the path from the name management table 111a, and issues duplication and transfer instructions designating the object ID₁ to the private storage 120. Then, the private storage 120 duplicates the file object corresponding to the object ID₁, and transfers the duplicated file object to the public storage 150 (S1001). The data management part 153 of the public storage 150 and the data management part 123 of the private storage 120 update the respective map management tables 121a and 151a.

Next, the client terminal issues a connection request and a delivery request (S1002), to request delivery of the file object.

Receiving the delivery request, the delivery server 110 sends the sequence number information of TCP to the router 160 before sending data containers (S1003). Based on the sequence number information, the data conversion part 164 of the router 160 updates the sequence management table 161a. After this update, it is possible to convert sequence numbers used for reliable transmission of data containers between the delivery server 110 and the router 160 into sequence numbers used for reliable transmission of TCP data between the router 160 and the client terminal 170.

The send processing part 113 of the delivery server 110 sends data containers to the router 160 through the IF part 115 (S1004).

The data conversion part 164 of the router 160 extracts the application protocol header from the received data containers. Further, the data conversion part 164 reads the file object corresponding to the object ID2 designated in the received data containers from the public storage 150 whose IP address is designated in the data containers. Then, the data conversion part 164 couples the file object with the application protocol header to generate TCP data (S1005). Further, the data conversion part 164 of the router 160 also converts the sequence numbers by using the sequence management table 161a.

Thus-generated TCP data are delivered from the router 160 to the client terminal 170 (S1006).

Then, on receiving the TCP data, the client terminal 170 returns a transmittal confirmation. The data conversion part 164 of the router 160 converts the sequence number included in the transmittal confirmation and sends the converted sequence number to the delivery server 110 (S1007).

In the case where TCP data has been lost between the router 160 and the client terminal 170, the data conversion part 164 of the router 160 retransmits the TCP data stored in the retransmit buffer storage part 162.

Further, by adding send time information to the data containers sent from the delivery server 110, it is possible to control delivery timing of the TCP data delivered from the router 160 to the client terminal 170.

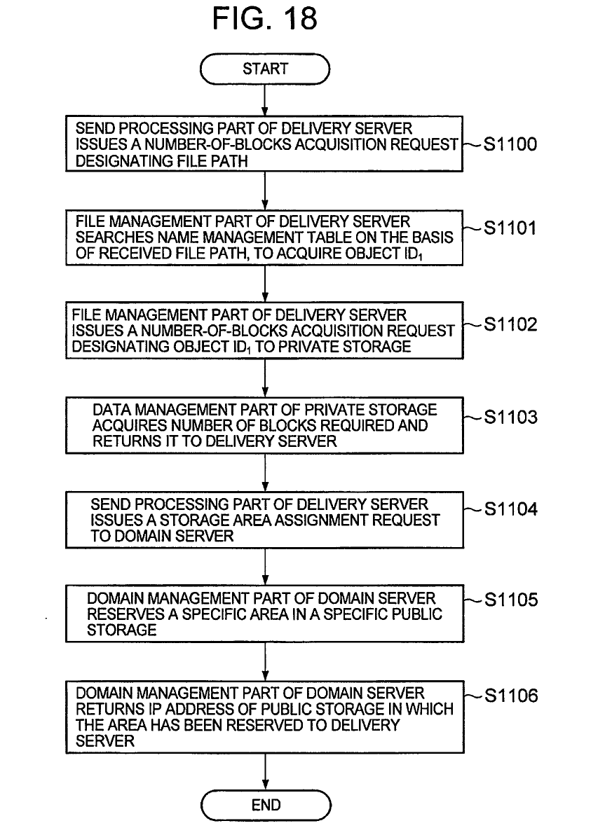

FIG. 18 is a flowchart showing processing of sending and receiving a storage area assignment request and a response to it between the delivery server 110 and the domain server 140.

First, the send processing part 113 of the delivery server 110 issues a number-of-blocks acquisition request designating a file path to the file management part 114 (S1100).

Next, the file management part 114 of the delivery server 110 divides the received file path into path elements and follows the name management table 111a stored in the name management information storage part 111 from the root directory 111b, to obtain the object ID₁ of the file object corresponding to the designated file path (S1101).

Next, the file management part 114 of the delivery server 110 issues a number-of-blocks acquisition request designating the object ID₁ to the private storage 120 (S1102).

Next, the data management part 123 of the private storage 120 searches the map management table 121a stored in the map management information storage part 121 to specify the entry whose object ID field 121b stores the object ID₁ designated in step S1102, and returns, as the number of blocks, the value of the corresponding size information field 121e to the send processing part 113 (S1103).

Next, the send processing part 113 of the delivery server 110 issues a storage area assignment request to the domain server 140 (S1104). In the storage area assignment request, the IP address of the private storage 120 corresponding to the delivery server 110, the object ID1 acquired in step S1101 and the number of blocks acquired in step S1102 are designated.

Next, the domain management part 142 of the domain server 140 searches for a public storage management table 141a to specify the entry whose free capacity field 141d stores the maximum value, and reserves an area in the public storage 150 corresponding to that entry (S1105). Then, the domain management part 142 stores information specifying the IP address of the private storage 120, the object ID₁ and the number of blocks included in the storage area assignment request into the private storage IP address field 141e, the object ID field 141f and the number-of-blocks field 141g of the entry in question. Further, the value of the free capacity field 141d is reduced by the number of reserved blocks.

Next, the domain management part 142 returns the IP address of the public storage 150 in which the area has been reserved to the delivery server 110 through the IF part 143 (S1106).

The send processing part 113 of the delivery server 110 is activated at regular time intervals to issue a storage area assignment continuation request to the domain server 140 through the IF part 115. Each continuation request may store the same information as the information stored in the storage area assignment request sent in step S1104.

Receiving such a storage area assignment continuation request, the domain server 140 clears to “0” the time-out value stored in the time-out field 141h of the public storage management table 141a.

On the other hand, the domain management part 142 of the domain server 140 is activated at regular intervals to increment all the time-out values stored in the time-out field 141h of the public storage management table 141a, and forcedly frees the assignment of a storage area whose time-out value becomes a prescribed value or larger. In detail, the corresponding fields 141e-141h are freed, and the free capacity field 141d is increased by the registered number of blocks.

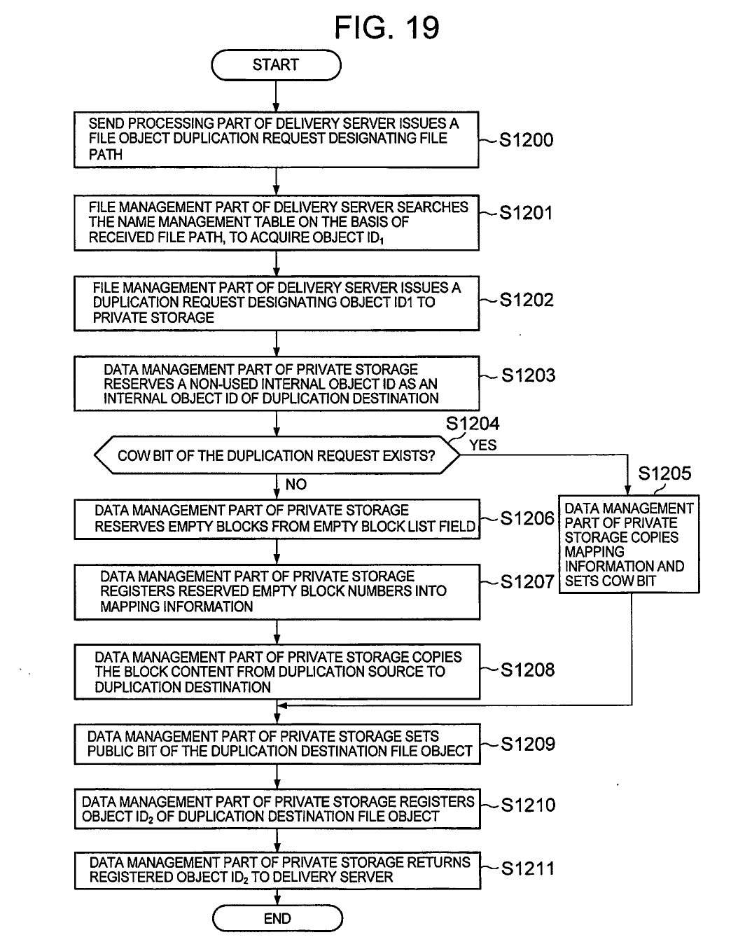

FIG. 19 is a flowchart showing processing of sending and receiving a file object duplication request and a response to it between the delivery server 110 and the private storage 120.

The send processing part 113 of the delivery server 110 issues a file object duplication request designating a file path to the file management part 114 (S1200).

Next, the file management part 114 of the delivery server 110 divides the received file path into path elements, and follows the name management table 111a from the root directory 111b to obtain the object ID₁ of the file object corresponding to the designated file path (S1201).

Next, the file management part 114 of the delivery server 110 issues a file object duplication request to the private storage 120 through the IF part 115 (S1202).

Here, the file object duplication request issued in step S1202 includes the object ID₁ obtained in step S1201, a duplication destination file object public/non-public bit specifying publication or non-publication of the duplication destination file object, and a COW bit specifying execution of virtual copy or physical copy. As for each of the duplication result file object public/non-public bit and the COW bit, it is possible, for example, that the bit is normally set to one selection and the operator of the delivery server 110 gives an instruction to set the bit to the other selection through the input unit as the case may be.

Next, the data management part 123 of the private storage 120 reserves an internal object ID that is not used in the internal object ID field 121c of the map management table 121a stored in the map management information storage part 121, and generates a new entry in the map management table 121a to store the reserved internal object ID in the internal object ID field 121c (S1203).

Next, the data management part 123 of the private storage 120 examines the COW bit included in the file object duplication request received in step S1202 (S1204). When the bit is on, the processing jumps to step S1205. Otherwise, the processing proceeds to step S1206.

Here, in step S1205, the data management part 123 of the private storage 120 copies the information stored in the mapping information field 121f corresponding to the object ID₁ of the duplication source file object into the entry reserved in step S1203, and puts the COW bit in all the mapping information fields 121f of both the duplication source and destination. Then, the processing jumps to step S1209.

In step S1206, based on the free block list field 121g of the map management table 121a, the data management part 123 of the private storage 120 reserves empty blocks corresponding to the number (of blocks) stored in the size information field 121e of the entry corresponding to the duplication source file object in the map management table 121a.

Next, the data management part 123 of the private storage 120 registers the block numbers of the empty blocks reserved in step S1206 into the mapping information field 121f of the duplication destination entry in the map management table 121a (S1207).

Next, the data management part 123 of the private storage 120 performs physical copy of the block content from the blocks specified in the mapping information field 121f of the entry corresponding to the duplication source file object in the map management table 121a to the blocks specified by the block numbers stored in the mapping information fields 121f of the entry corresponding to the duplication destination file object in the map management table 121a (S1208).

Next, based on the public bit included in the file object duplication request received in step S1202, the data management part 123 of the private storage 120 sets the public bit stored in the public/non-public bit field 121d of the entry corresponding to the duplication destination file object in the map management table 121a (S1209). Further, the data management part 123 sets the size information of the entry corresponding to the duplication destination file object in the map management table 121a to the same value as the value of the size information stored in the entry corresponding to the duplication source file object.

Next, the data management part 123 of the private storage 120 generates an object ID₂ by combining its own IP address with the internal object ID reserved in step S1203, and stores the generated object ID₂ in the object ID field 121b of the entry corresponding to the duplication destination file object in the map management table 121a (S1210).

Next, the data management part 123 of the private storage 120 returns the object ID₂ generated in step S1210 together with the object ID₁ to the delivery server 110 (S1211).

Receiving the object ID₂, the file management part 114 of the delivery server 110 generates a new entry in the ID management information table 112a stored in the ID management information storage part 112, and stores the path name of the file object corresponding to the object ID₁ into the path name field 112b, and the object ID₂ into the object ID field 112c. Further, the file management part 114 stores the IP address of the public storage 150, which has been returned in step S1106 of FIG. 18, into the public storage IP address field 112d.

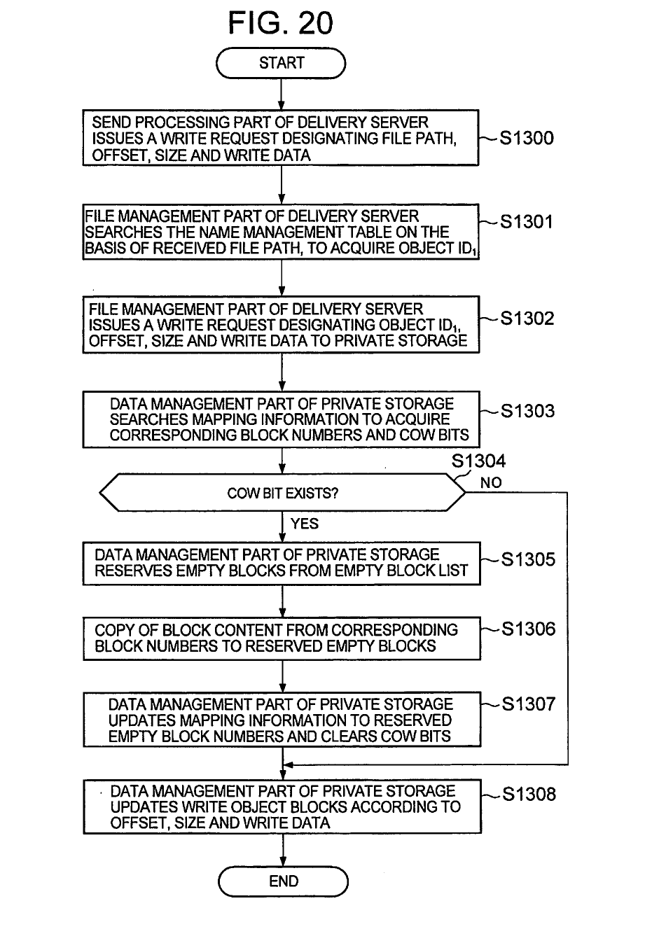

In the case where the COW bit has been set in the file object duplication request in the flowchart of FIG. 19, physical copy of the blocks is not performed. In order that the contents of the file objects other than the write object may not be updated when a write request with respect to the duplication source or destination file object arrives later, the flowchart of delayed copy shown in FIG. 20, for example, is executed.

First, the send processing part 113 of the delivery server 110 issues a write request designating a file path, offset, size, and data to be written to the file management part 114 (S1300).

Next, the file management part 114 of the delivery server 110 divides the received file path into path elements, and follows the name management table 111a stored in the name management information storage part 111 from the root directory 111b, to obtain the object ID₁ corresponding to the designated file path (S1301).

Next, the file management part 114 of the delivery server 110 issues a write request to the private storage 120 (S1302). At that time, the write request is made to include the object ID₁ obtained in step S1301, the offset designated in step S1300, size, and the data to be written.

Next, the data management part 123 of the private storage 120 searches the map management information storage part 121 to specify the entry whose object ID field 121b stores the object ID₁ designated in step S1302. Then, the data management part 123 acquires the block numbers and the COW bit corresponding to the offset and the size designated in step S1302, from the mapping information field 121f of the specified entry (S1303).

Next, the data management part 123 of the private storage 120 examines the COW bit obtained in step S1303 (S1304). When the COW bit is on, the processing proceeds to step S1305. Otherwise, the processing jumps to step S1308.

In step S1305, the data management part 123 of the private storage 120 reserves one empty block on the basis of the free block list field 121g of the map management table 121a.

Next, the data management part 123 of the private storage 120 performs physical copy of the block content from the blocks corresponding to the block numbers obtained in step S1303 to the empty blocks reserved in step S1305 (S1306).

Next, the data management part 123 of the private storage 120 updates the block numbers that are stored in the mapping information field 121f and obtained in step S1303 to the block numbers of the empty blocks obtained in step S1305, and further clears the corresponding COW bits (S1307).

Next, the data management part 123 of the private storage 120 updates the block content according to the offset, the size and the data to be written designated in step S1302 (S1308).

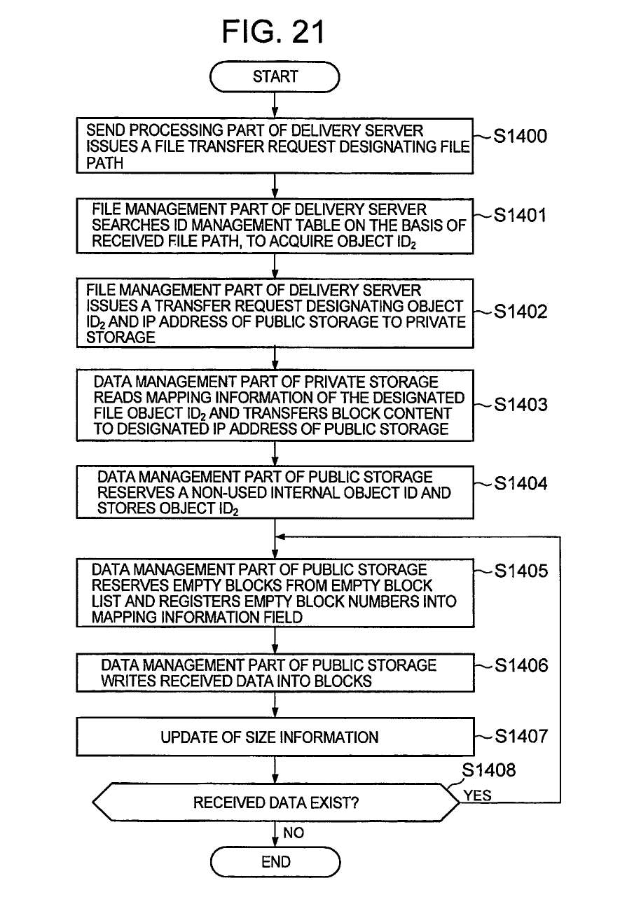

FIG. 21 is a flowchart showing processing of sending and receiving a file object transfer request and a response to it between the delivery server 110 and the private storage 120.

First, the send processing part 113 of the delivery server 110 issues a file transfer request, which is directed to the private storage 120 and designates a file path name, to the file management part 114 (S1400). At that time, the IP address obtained in step S1106 of FIG. 18 is designated as the IP address of the public storage 150 as the destination of the transfer.

Next, the file management part 114 of the delivery server 110 obtains the object ID₂ corresponding to the received file path name from the ID management information table 112a stored in the ID management information storage part 112 (S1401).

Next, the file management part 114 of the delivery server 110 issues a file object transfer request to the private storage 120 through the IF part 115 (S1402). Here, the file object transfer request includes the object ID₂ obtained in step S1401 and the IP address of the public storage 150 designated in step S1400.

Next, the data management part 123 of the private storage 120 searches the map management table 121a stored in the map management information storage part 121 through the IF part 124, to specify the entry whose object ID field 121b stores the object ID₂ designated in step S1402. Then, the data management part 123 extracts the block numbers from the mapping information field 121f of the entry in question, and transfers the block content corresponding to the block numbers together with the object ID₂ designated in step S1402 to the IP address of the public storage 150 designated in step S1402 (S1403).

Next, the data management part 153 of the public storage 150 searches the map management table 151a stored in the map management information storage part 151, to reserve an unused internal object ID. Then, the data management part 153 reserves a new entry in the map management table 151a and stores the reserved internal object ID in the internal object ID field 151c of the new entry. Further, the data management part 153 stores the object ID₂ of the file object, which has been received from the private storage 120, into the object ID field 151b of the entry (S1404). Further, the data management part 153 sets the public bit of the entry.

Next, the data management part 153 of the public storage 150 reserves empty blocks on the basis of the free block list field 151g of the map management table 151a, and registers the block numbers of the reserved empty blocks into the mapping information field 151f of the entry reserved in step S1404 (S1405).

Next, the data management part 153 of the public storage 150 writes the data received in step S1403 into the blocks reserved in step S1405 (S1406).

Next, the data management part 153 of the public storage 150 increments the number of blocks, which is stored in the size information field 151e of the entry reserved in step S1404 (S1407).

Next, the data management part 153 of the public storage 150 examines whether all the data received in step S1403 have been written into the blocks in step S1406 (S1408). When all the data have been written, the processing is ended. Otherwise, the processing is repeated from step S1405.

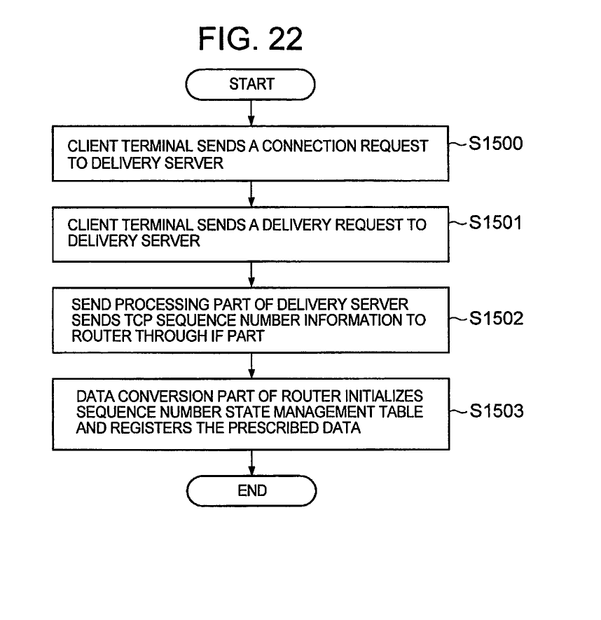

FIG. 22 is a flowchart showing processing of sending and receiving a connection request and a response to it between the client terminal 170 and the delivery server 110 and processing of sending and receiving TCP sequence state information between the delivery server 110 and the router 160.

First, the client terminal 170 sends a connection request, which includes the IP address of the delivery server 110, the port number of the delivery server 110, the IP address of the client terminal 170 and the port number of the client terminal 170, to the delivery server 110 (S1500). When the delivery server 110 receives the connection request, the send processing part 113 sends a response including an execution result to the client terminal 170 through the IF part 115. For example, in cases where the delivery server's port number included in the connection request is predetermined, the send processing part 113 sends a connection success response to the client terminal 170.

Next, when the connection with the delivery server 110 is established successfully, the client terminal 170 sends a delivery request, which includes the IP address of the delivery server 110, the port number of the delivery server 110, the IP address of the client terminal 170, the port number of the client terminal 170 and the file path name of a file object, to the delivery server 110 (S1501). Receiving the delivery request, the send processing part 113 of the delivery server 110 sends a response including an execution result to the client terminal 170 through the IF part 115.

Next, when the delivery request is received successfully, the send processing part 113 of the delivery server 110 sends TCP sequence state information, which includes the IP address of the delivery server 110, the port number of the delivery server 110, the IP address of the client terminal 170, the port number of the client terminal 170 and an initial sequence number, to the router 160 (S1502). Here, the initial sequence number is a sequence number that the send processing part 113 of the delivery server 110 uses at the time of sending the first data container.

Next, based on the received TCP sequence state information, the data conversion part 164 of the router 160 initializes the sequence management table 161a stored in the sequence management information storage part 161, and stores the IP address of the delivery server 110, the IP address of the client terminal 170, the port number of the delivery server 110 and the port number of the client terminal 170 included in the received TCP sequence state information into the delivery server IP address field 161e, the client IP address field 161a, the delivery server port number field 161g and the client port number field 161h. Further, the data conversion part 164 stores the initial sequence number included in the received TCP sequence state information into the snd_max field 161b, the snd_nxt field 161c and the snd_una field 161d. Further, the data conversion part 164 stores “0” as the initial value into the retransmit timer field 161i (S1503).

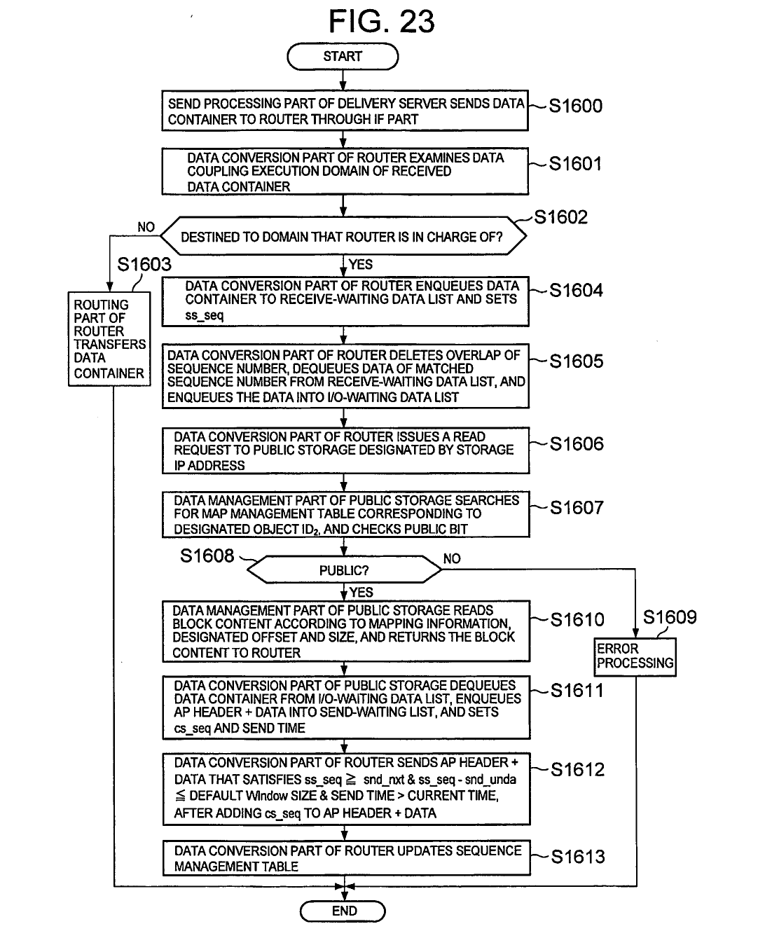

FIG. 23 is a flowchart showing processing of sending and receiving a data container between the delivery server 110 and the router 160 and processing of sending and receiving TCP data between the router 160 and the client terminal 170.

First, the send processing part 113 of the delivery server 110 sends a data container to the router (S1600).

Here, in a data container 182 shown in FIG. 13A, the delivery server IP address storage area 182a stores the IP address of the delivery server 110, the client IP address storage area 182b the IP address of the client terminal 170, the delivery server port number storage area 182c the port number of the delivery server 110, and the client port number storage area 182d the port number of the client terminal 170, information stored in the connection request sent in step S1500 of FIG. 22 is stored therein.

Further, the sequence number storage area 182e stores a value that is obtained by adding the accumulated size of the data containers sent up to now, to the initial sequence number stored in the TCP sequence state information sent in step S1502 of FIG. 22.

Further, the AP protocol header storage area 182f stores a value corresponding to an application protocol header that is generated by processing an application protocol stack in the send processing part 113. Application headers are stored in the AP header field 112e of the ID management information table 112a.

Further, the data coupling execution domain storage area 182g stores the domain name to which the domain server 140 as the sender of the storage area assignment request in step S1104 of FIG. 18 belongs.

Further, the storage IP address storage area 182h stores the IP address of the public storage, which has been obtained in step S1106 of FIG. 18.

Further, the file object ID storage area 182i stores the object ID₂ obtained in step S1211 of FIG. 19.

Further, the offset storage area 182j, the size storage area 182k and the send time storage area 182l store suitable values according to data sent by the send processing part 113 and send timing.

Next, the data conversion part 164 of the router 160 examines whether a data coupling execution domain stored in the received data container is the same as the domain that its own router 160 is in charge of (S1601).

When it is judged in step S1601 that the domain in question is not the domain its own router 160 is in charge of, the data container received in step S1600 is transferred to the client terminal 170 (S1603), and the processing is ended.

When, on the other hand, it is judged in step S1601 that the domain in question is the domain its own router 160 is in charge of, the processing proceeds to step S1604.

In step S1604, based on the IP address of the delivery server 110, the IP address of the client terminal 170, the port number of the delivery server 110 and the port number of the client terminal 170 stored in the received data container, the data conversion part 164 of the router 160 searches the corresponding TCP sequence management table 161a, and queues the received data container in the reception-waiting data list 162a of the retransmit buffer storage part 162. At that time, the value of ss_seq is set to the sequence number stored in the data container.

Next, based on values of ss_seq and sizes of data containers, the data conversion part 164 of the router 160 deletes overlaps in the reception-waiting data list 162a, and moves the data container of the matched sequence number from the reception-waiting data list 162a to the I/O-waiting data list 162b (S1605).

Next, in accordance with the IP address of the public storage 150, the object ID₂, the offset and the size specified in the data container enqueued in the I/O-waiting data list 162b in step S1605, the data conversion part 164 of the router 160 issues a read request of the designated file object to the corresponding public storage 150 (81606).

Next, the data management part 153 of the public storage 150 searches the map management table 151a stored in the map management information storage part 151, to specify the entry whose object ID field 151b stores the object ID₂ specified in the read request sent in step S1606. Then, the data management part 153 examines whether the public/non-public bit field 161d of the entry has been set to the public bit (S1607). When the public bit is not stored (S1608), reading is made to fail, and an error response is sent to the router 160 (S1609).

When it is found in step S1608 that the public bit is stored, the data management part 153 of the public storage 150 determines the block number registered in the mapping information field 161f of the entry specified in step S1607 on the basis of the offset and the size included in the read request received in step S1606. Then, based on the determined block number, the data management part 153 reads the data of the block and sends the data to the router 160 (S1610).

Next, the data conversion part 164 of the router 160 dequeues the data container enqueued in step S1605 from the I/O-waiting data list 162b. Then, the data conversion part 164 generates TCP data by storing the IP address of the delivery server 110, the IP address of the client terminal 170, the port number of the delivery server 110, the port number of the client terminal 170 and the application protocol header included in the data container into the delivery server IP address storage area 183b, the client IP address storage area 183b, the delivery server port number storage area 183c, the client port number storage area 183d and the application protocol header storage area 183f of TCP data 183 shown in FIG. 13B, and the data received in step S1609 into the data storage area 183g of the TCP data 183. Then, the data conversion part 164 enqueues the generated TCP data into the send-waiting data list 162c. At that time, the send time is read from the received data container and stored. Further, the value of cs_seq is stored on the basis of sc_seq of the TCP data enqueued last into the send-waiting data list 162 and the TCP data size (S1611).

Next, the data conversion part 164 of the router 160 judges whether TCP data enqueued in the send-waiting data list 162c can be sent or not, and sends sendable TCP data to the client terminal 170 through the second IF part 166 (S1612).

Here, whether TCP data are sendable or not is judged as follows. That is, the sequence management table 161a corresponding to the IP address of the delivery server 110, the IP address of the client terminal 170, the port number of the delivery server 110 and the port number of the client terminal 170 stored in the TCP data is searched for. Thereafter, it is judged whether three conditions (1) ss_seq>=snd_nxt, (2) ss_seq and snd_una are smaller than the default window size, and (3) the send time>the current time are all satisfied. As the sequence number of the sendable TCP data, the value stored in cs_seq is designated. As the values of the other fields, the values enqueued in the send-waiting data list 162c are designated.

Then, the data conversion part 164 of the router 160 increments the value of the snd_nxt field 161c of the sequence management table 161a by the size of the sent TCP data. As a result, in cases where the value stored in the snd_nxt field 161c exceeds the value stored in the snd_max field 161b, the value stored in the snd_max field 161b is updated to the value stored in the snd_nxt field 161c (S1613).

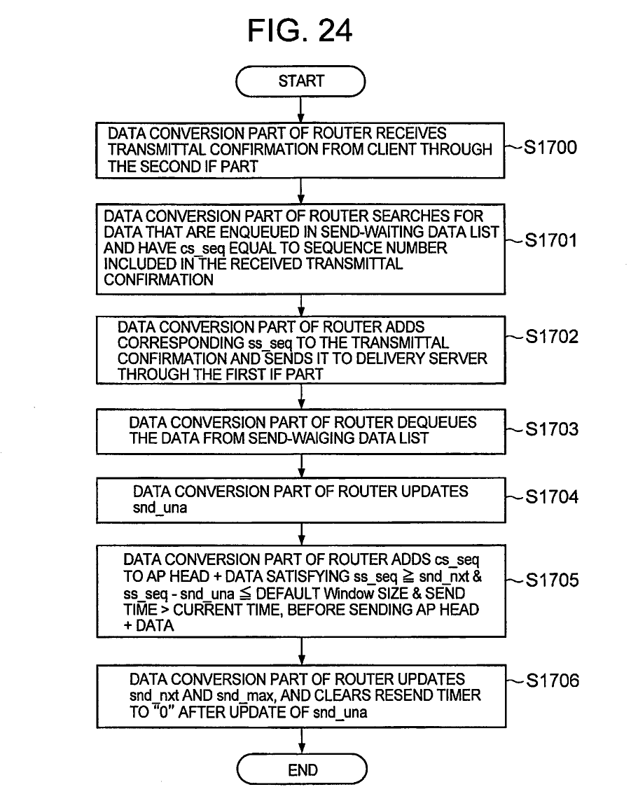

FIG. 24 is a flowchart showing processing of sending and receiving a transmittal confirmation between the client terminal 170 and the router 160 and between the router 160 and the delivery server 110.

First, when the client terminal 170 receives TCP data, the client terminal 170 sends a transmittal confirmation to the router. The data conversion part 164 of the router 160 receives the transmittal confirmation through the second IF part 166 (S1700). Here, the transmittal confirmation includes the IP address of the delivery server 110, the IP address of the client terminal 170, the port number of the delivery server 110 and the port number of the client terminal 170, using the values stored in the TCP data sent in step S1612 of FIG. 23. Further, the transmittal confirmation also includes the sequence number. The value obtained by adding the size of the received TCP data to the sequence number stored in the received TCP data is stored as this sequence number.

Next, the data conversion part 164 of the router 160 searches the sequence management information storage part 161 for the sequence management table corresponding to the IP address of the delivery server 110, the IP address of the client terminal 170, the port number of the delivery server 110 and the port number of the client terminal 170 stored in the received transmittal confirmation. Further, the data conversion part 164 searches the send-waiting data list 162c corresponding to these values for TCP data whose cs_seq value corresponds to the sequence number stored in the received transmittal confirmation (S1701).

Next, the data conversion part 164 of the router 160 stores the value of ss_seq of the TCP data retrieved in step S1701 into the corresponding area in the received transmittal confirmation, i.e. the area for storing the sequence number. Then, the data conversion part 164 sends the transmittal confirmation to the delivery server 110 through the first IF part 165 (S1702).

Next, the data conversion part 164 of the router 160 dequeues the TCP data enqueued in the send-waiting data list 162c before the TCP data retrieved in step S1701 (S1703).

Next, when the value stored in the snd_una field 161d is smaller than the sequence number stored in the transmittal confirmation received in step S1700, the data conversion part 164 of the router 160 updates the value stored in the snd_una field 161d to the sequence number (S1704).

Next, the data conversion part 164 of the router 160 sends the TCP data queued in the send-waiting data list 162c to the client terminal 170 through the second IF part 166 according to algorithm similar to the algorithm of step S1611 of FIG. 23 (S1705).

Next, the data conversion part 164 of the router 160 updates the values stored in the snd_nxt field 161c and the snd_max field 161b according to an algorithm similar to the algorithm of step S1612 of FIG. 23. Further, in cases where the snd_una field 161d has been updated in step S1704, the data conversion part 164 clears to “0” the value stored in the retransmit timer field 161i of the sequence management table 161a retrieved in step S1701 (S1706).

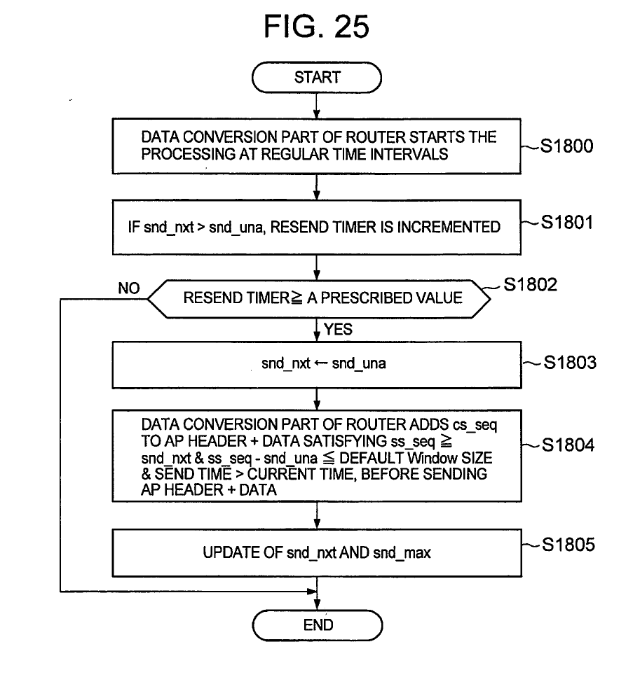

Here, there are some cases where TCP data sent from the router 160 to the client terminal 170 in the flow of FIG. 23 are lost along the way, and a transmittal confirmation according to the flow of FIG. 24 does not arrive at the router 160. In such cases, it is necessary that the router 160 detect the loss of the TCP data and retransmit the TCP data. To perform such retransmitting, the router 160 performs the flowchart of retransmitting shown in FIG. 25 at regular time intervals.

The data conversion part 164 of the router 160 is activated at regular intervals to perform processing of steps S1801-S1805 with respect to all the sequence state management tables 161a managed by the data conversion part 164 (S1800).

First, with respect to any sequence state management table 161a that has not been processed yet, the data conversion part 164 of the router 160 increments the value stored in the retransmit timer field 161i when the value stored in the snd_max field 161b of the table 161a in question is larger than the value stored in the snd_una field 161d (S1801).

Next, the data conversion part 164 of the router 160 judges whether the value stored in the retransmit timer field 161i exceeds a prescribed value or not (S1802). When the value does not exceed the prescribed value, the processing is ended and the next table is checked.

On the other hand, if the value exceeds the prescribed value, the data conversion part 164 of the router 160 updates the value stored in the snd_nxt field 161c to the value stored in the snd_una field 161d (S1803).

Next, the data conversion part 164 of the router 160 sends the TCP data queued in the send-waiting data list 162c to the client terminal 170 through the second IF part 166 according to an algorithm similar to the algorithm of step S1611 of FIG. 23 (S1804).

Next, the data conversion part 164 of the router 160 updates the values stored in the snd_nxt field 161c and the snd_max field 161b according to an algorithm similar to the algorithm of step S1612 of FIG. 23 (S1805).

As described above, according to the present embodiment, the delivery server 110 generates an application header corresponding to an application protocol, and the router 160 can obtain a file object accumulated in the public storage 150 and generate TCP data. As a result, the router 160 can reduce the load on the delivery server 110. In addition, it is not necessary that an application protocol stack corresponding to applications used by the delivery server 110 be installed in the router 160.

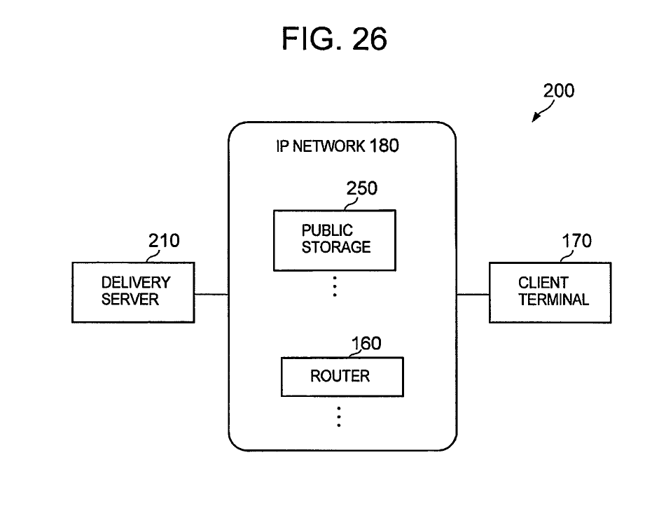

According to the above-described embodiment, a file object corresponding to content data to be delivered to the client terminal 170 is transferred from the private storage 120 to the public storage 150 through the storage network 181. This mode is not restrictive. For example, it is possible to arrange the delivery system as the delivery system 200 as shown in FIG. 26 (a schematic block diagram showing the delivery system 200).

As shown in the figure, the delivery system 200 comprises a delivery server 210, a public storage 250, the router 160 and the client terminal 170. These component units can send and receive information to and from each other through the IP network.

In the delivery system 200 of the described configuration, file objects stored in an external storage of the delivery server 210 are previously sent to and accumulated in the public storage 250. The delivery system 200 brings about the same effect as the above-described delivery system 100.

Further, in the above-described embodiment, the client terminal 170 sends a delivery request specifying a path name of a file object to the delivery server 110. This mode is not restrictive. For example, a delivery request specifying an object ID (an object ID₁ or an object ID₂) of a file object may be sent. Or, other identification information for identifying a file object may be sent to the delivery server 110. In that case, the ID management information storage part 112 of the delivery server 110 may store a table that associates identification information sent from the client terminal 170 with an object ID₂.

In the above-described embodiment, file objects stored in the private storage 120 are transferred in advance to the public storage. Thereafter, the delivery server 110 receives a delivery request from the client terminal 170. This mode is not restrictive. For example, a file object may be transferred after a delivery request is received from the client terminal 170.

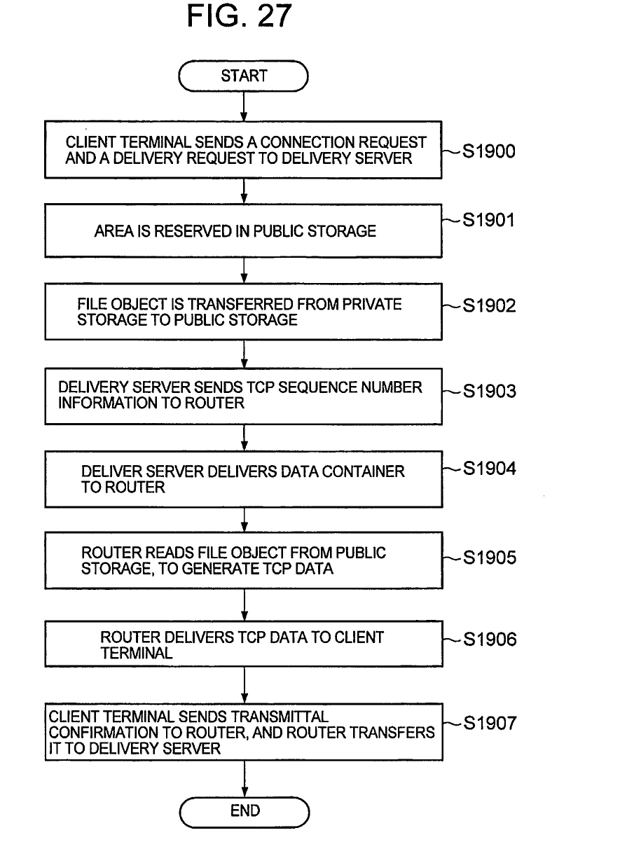

In such cases, a file object may be transferred according to a flowchart as shown in FIG. 27, for example.

First, the client terminal 170 sends a connection request and a delivery request to the delivery server 110 (S1900).

Next, the send processing part 113 of the delivery server 110 issues a storage area assignment request (and thereafter, assignment continuation requests at regular time intervals) to the domain server 140, to reserve an area of a certain size in the public storage 150 (S1901).

Next, the send processing part 113 and the file management part 114 of the delivery server 110 sends the private storage 120 a duplication request of a file object designated by a path and a transfer request for transferring the duplicated file object to the public storage 150. The private storage 120 transfers the designated file object to the public storage 150 (S1902). At that time, an update of the map management table 121a in the private storage 120 and an update of the map management table 151a in the public storage 150 are performed in addition.

Next, after sending the transfer request to the private storage 120, the send processing part 113 of the delivery server 110 sends TCP sequence number information to the router 160 (S1903). Based on the TCP sequence number information, the data conversion part 164 of the router 160 updates the sequence management table 161a. As a result of the update, thereafter, a sequence number used for reliable transmission of a data container between the delivery server 110 and the router 160 can be converted into a sequence number used for reliable transmission of TCP data between the router 160 and the client terminal 170.

Next, the send processing part 113 of the delivery server 110 sends a data container (S1904).

Next, the data conversion part 164 of the router 160 extracts the application protocol header from the received data container. Further, the data conversion part 164 reads the data corresponding to the object ID₂, the offset and the size included in the data container from the public storage 150 designated in the data container. Then, the data conversion part 164 couples the read data with the application protocol header to generate TCP data (S1905).

Next, the routing part 163 of the router 160 sends the TCP data generated in step S1905 to the client terminal 170 through the second IF part 166 (S1906). Further, the data conversion part 164 of the router 160 also converts the sequence number by using the sequence management table 161a. Further, the data container stores the send time information. Even if the delivery server 110 sends the data container earlier than the send time, the data conversion part 164 of the router queues the data container in question and sends the TCP data to the client terminal 170 at the proper send time.

Next, on receiving the TCP data, the client terminal 170 returns a transmittal confirmation. The data conversion part 164 of the router 160 converts the sequence number included in the transmittal confirmation and transfers the transmittal confirmation to the delivery server 110 (S1907).

When the processing is performed according to the above-described flow, the public storage 150 can buffer file objects. Even if fluctuation of transmission delay occurs, TCP data can be sent from the router 160 to the client terminal at stable send-timing, and QoS of data transfer can be ensured.

Further, in the above-described embodiment, the router 160 couples a file object with an application header to generate TCP data. This mode is not restrictive. For example, a communication apparatus (server) having a similar configuration to the configuration of the router 160 may be arranged in the IP network 180 so that the communication apparatus couples a file object with an application header to generate TCP data.

Further, in the above-described embodiment, the AP header field 112e of the ID management information table 112a stores in advance an application header to be sent being stored in a data container. This mode is not restrictive. For example, the send processing part 113 of the delivery server 110 may generate an application header when a delivery request is received from the client terminal 170, or when a duplication request for requesting duplication in the private storage 120 is issued, or when a transfer request for requesting transfer to the public storage 150 is issued, for example. In such cases, it is preferable that file objects are previously stored in an external storage of the delivery server 110.

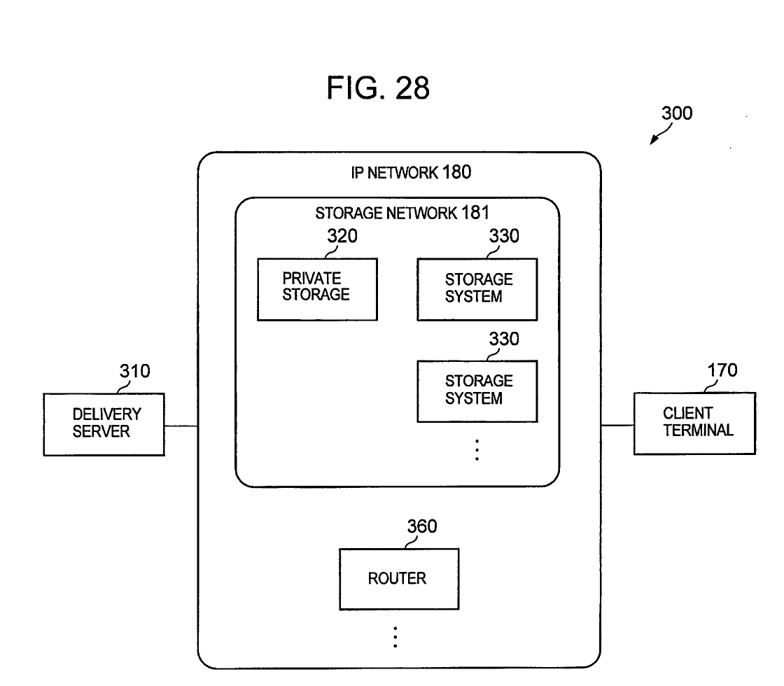

FIG. 28 is a schematic block diagram showing a delivery system 300 as a second embodiment of the present invention.

As shown in the figure, the delivery system 300 comprises a delivery server 310, a private storage 320, storage systems 330, a router 360, and a client terminal 170, similarly to the first embodiment.

The delivery server 310 and the client terminal 170 can communicate with each other through the IP network 180. The router 360 is arranged in the IP network 180.

Further, a storage network 181 is provided in the IP network 180. The private storage 320 and the storage systems 330, which are provided in the storage network 181, can communicate with each other within the storage network 181. The private storage 320 and the storage systems 330 can communicate with the delivery server 310, the router 360 and the client terminal 170 through the IP network 180.

Here, in the present embodiment, the delivery server 310 sends data to the client terminal 170 according to User Datagram Protocol (UDP). The router 360 stores a part of the UDP data sent in this way into a public storage 350 connected within a storage system 330, so that a history of UDP data passing through the router 360 can be managed. As a result, when a failure occurs in the IP network 180 and UDP data sent from the delivery server 310 toward the client terminal 170 are lost, it is possible to identify in which part of the IP network the failure has occurred.

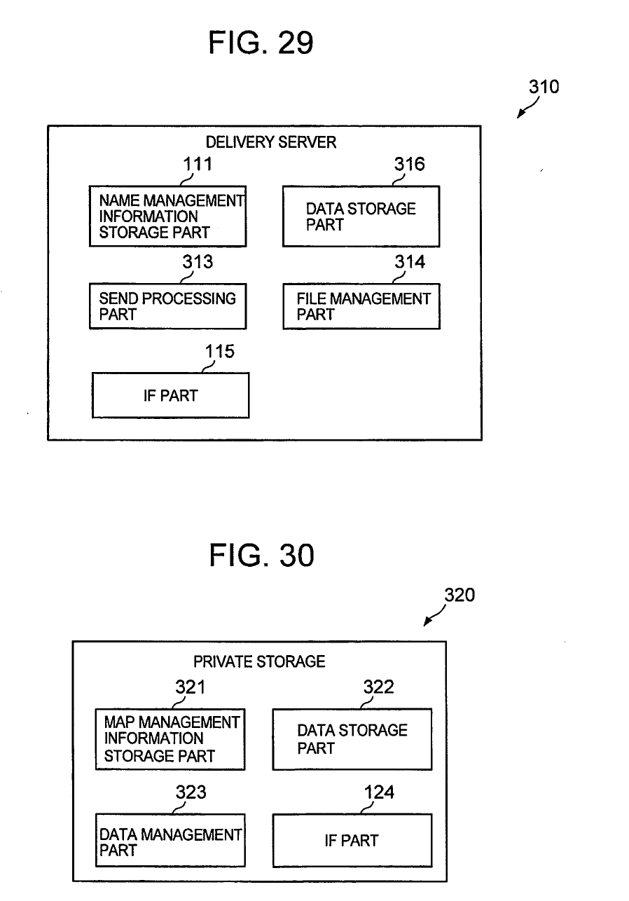

FIG. 29 is a schematic diagram showing the delivery server 310.

As shown in the figure, the delivery server 310 comprises a name management information storage part 111, a send processing part 313, a file management part 314, an IF part 115 and a data storage part 316.

The name management information storage part 111 stores information that specifies: a path name; and information (an object ID) identifying a file object corresponding to that path name. Similarly to the first embodiment, the name management information storage part 111 stores a name management table 111a as shown in FIG. 3, for example.

The send processing part 313 controls processing of delivering, as UDP data, a file object stored in the data storage part 316, in response to a connection request and a delivery request from the client terminal 170.

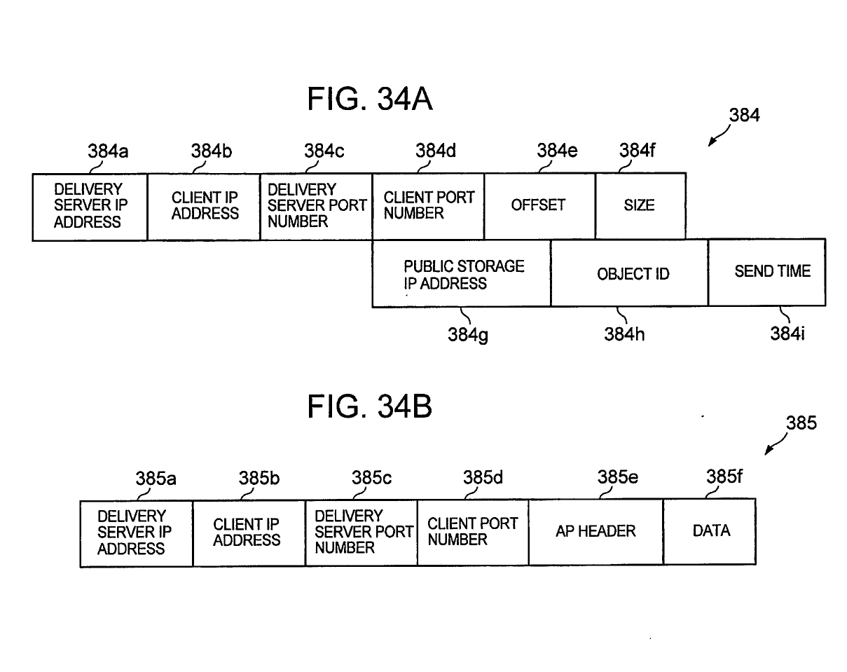

Here, UDP data 385 as shown in FIG. 34B may be sent to the client terminal 170.

Further, in the present embodiment, the send processing part 313 controls processing of issuing a storage area assignment request to a domain server 340, similarly to the first embodiment.

Further, before sending UDP data to the client terminal 170, the send processing part 313 controls processing of sending duplication management information to the router 360. Duplication management information specifies which part of the UDP data should be duplicated and which public storage 350 should store the duplicate.

Here, duplication management information 384 as shown in FIG. 34A is sent to the router 360.

Duplication management information 384 has a delivery server IP address storage area 384a, a client IP address storage area 384b, a delivery server port number storage area 384c, a client port number storage area 384d, an offset storage area 384e, a size storage area 384f, a public storage IP address storage area 384g, an object ID storage area 384h and a send time storage area 384i. Information to be stored in these storage areas will be described later.

Further, the send processing part 313 controls processing of sending an acquisition request designating a send history object ID and the IP address of the private storage 320 to the public storage 350, and transferring a send history object from the public storage 350 to the private storage 320 to put the history object into the delivery server 310

The file management part 314 manages information stored in the name management information storage part 111 and the data storage part 316.

The IF part 115 is an interface for sending and receiving information through the IP network 180.

The data storage part 316 stores file objects to be sent to the client terminal 170.

The delivery server 310 can be implemented by a computer 190 as shown in FIG. 14 also.

For example, the name management information storage part 111 and the data storage part 316 can be implemented by the external storage 191. The send processing part 313 and the file management part 314 can be implemented when prescribed programs stored in the external storage 191 are loaded into the memory 192 and executed by the CPU 193. The IF part 115 can be implemented by the communication unit 196.

FIG. 30 is a schematic diagram showing the private storage 320.

As shown in the figure, the private storage 320 comprises a map management information storage part 321, a data storage part 322, a data management part 323 and an IF part 124.

The map management information storage part 321 stores at least identification information for identifying a send history file object and information indicating the storage location of the send history file object, for each send history file object stored in the data storage part 322.

For example, also in the present embodiment, the map management information storage part 321 stores a map management table 121a as shown in FIG. 6. However, data stored in the map management table 121a are different from data in the first embodiment.

As shown in the figure, the map management table 121a has an object ID field 121b, an internal object ID field 121c, a public/non-public bit field 121d, a size information field 121e, a mapping information field 121f and an free block list field 121g.

The object ID field 121b stores information (a send history file object ID) for identifying a send history file object corresponding to the entry in question.

The internal object ID field 121c stores information for identifying the send history file object corresponding to the entry in question. Each time when a new file to be stored in the data storage part 322 of the private storage 320 is generated, the data management part 323 generates identification information (ID) of the newly-generated file and stores the generated ID in the internal object ID field 121c.

In order to be able to know which send history file object is stored in a private storage 320, a unique identification information (ID) stored in the object ID field 121b is generated by combining the IP address of the private storage 320 in question with the identification information (ID) stored in the internal object ID field 121c.

The public/non-public bit field 121d stores information specifying whether the send history file object of the entry in question is opened to the public or not.

The size information field 121e stores information specifying the data size of the send history file object of the entry in question. In the present embodiment, the size information field 121e stores the number of blocks.

The mapping information field 121f stores information specifying the location in the data storage part 122, at which the send history file object of the entry in question is stored. In the present embodiment, the mapping information field 121f stores block numbers of blocks in the data storage part 322.

In the present embodiment, the mapping information field 121f stores not only block numbers but also COW bits so that virtual copy of the send history file object can be realized.

The data storage part 322 stores send history file objects.

The data management part 323 manages data stored in the map management information storage part 321 and the data storage part 322.

The IF part 124 is an interface for sending and receiving information through the IP network 180 and the storage network 181.

The above-described private storage 320 can be implemented by a computer as shown in FIG. 15 also.

For example, the map management information storage part 321 and the data storage part 322 can be implemented by the external storage 291. The data management part 323 can be implemented when prescribed programs stored in the external storage 291 are loaded into the memory 292 and executed by the CPU 293. The IF part 124 can be implemented by the communication unit 294.

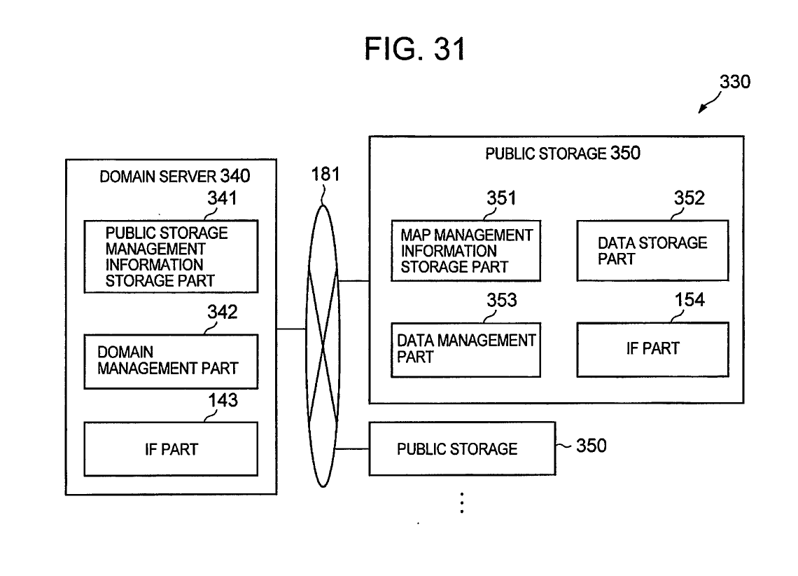

FIG. 31 is a schematic diagram showing a storage system 330.

As shown in the figure, a storage system 330 comprises a domain server 340 and one or more public storage 350. The domain server 340 and the public storages 350 can send and receive information to and from one another through the storage network 181.

The domain server 340 comprises a public storage management information storage part 341, a domain management part 342 and an IF part 143.

The public storage management information storage part 341 stores information for specifying send history file objects stored in the public storages 350 managed by the domain server 340.

For example, in the present embodiment also, the public storage management information storage part 341 stores a public storage management table 141a as shown in FIG. 8. However, data stored in the public storage management table 141a are different from data in the first embodiment.

As shown in the figure, a public storage management table 141a has a public storage IP address field 141b, a total capacity field 141c, a free capacity field 141d, a private storage IP address field 141e, an object ID field 141f, a number-of-blocks field 141g and a time-out field 141h. A public storage management table 141a is generated for each public storage 150 managed by the domain server 340.

The public storage IP address field 141b stores the IP address of a public storage 350 managed by the domain server 340.

The total capacity field 141c stores the total storage capacity assigned for storing file objects in the public storage 350 specified in the public storage IP address field 141b.

The free capacity field 141d stores free capacity out of the total storage capacity assigned for storing file objects in the public storage 350 specified in the public storage IP address field 141b.

The private storage IP address field 141e stores the IP address of a private storage 320 as a sending destination of a send history file object stored in the public storage 350 specified in the public storage IP address field 141b.

The object ID field 141f stores identification information for specifying a send history file object stored in the public storage 350 specified in the public storage IP address field 141b.

Here, in the present embodiment, the object ID field 141f stores a send history object ID included in a write request from the router 360.

The number-of-blocks field 141g stores the number of blocks assigned for storing a send history file object in the public storage 350 specified in the public storage IP address field 141b.

The time-out field 141h stores a time-out value for reservation of an area assigned for storing a file object in the public storage 350 specified in the public storage IP address field 141b. By managing such a time-out value, it is possible to free the area in question forcedly when an assignment continuation request for the area does not arrive from the delivery server 310 within a prescribed time (for example, owing to failure of the delivery server 310).

The domain management part 342 controls general processing in the domain server 340. In particular, in the present embodiment, the domain management part 342 manages information stored in the public storage management information storage part 341.

The IF part 143 is an interface for sending and receiving information through the IP network 180 and the storage network 181.

The domain server 340 also can be implemented by a computer as shown in FIG. 14.

For example, the public storage management information storage part 341 can be implemented by the external storage 191. The domain management part 342 can be implemented when prescribed programs stored in the external storage 191 are loaded into the memory 192 and executed by the CPU 193. The IF part 143 can be implemented by the communication unit 196.

Returning to FIG. 31, the public storage 350 comprises a map management information storage part 351, a data storage part 352, a data management part 353 and an IF part 154.

The map management information storage part 351 stores at least identification information for identifying a send history file object and information indicating the storage location of the send history file object, for each send history file object stored in the data storage part 352.

For example, in the present embodiment, the map management information storage part 351 stores a map management table 151a as shown in FIG. 9 similarly to the first embodiment. However, data stored in the map management table 151a are different from data in the first embodiment.

As shown in the figure, the map management table 151a has an object ID field 151b, an internal object ID field 151c, a public/non-public bit field 151d, a size information field 151e, a mapping information field 151f and an free block list field 151g.

The object ID field 151b stores information for identifying a send history file object corresponding to the entry in question.

Here, in the present embodiment, the object ID field 151b stores a send history object ID for identifying a send history file object sent from the router 360.

The internal object ID field 151c stores information for identifying the send history file object corresponding to the entry in question.

The public/non-public bit field 151d stores information specifying whether the send history file object corresponding to the entry in question is opened to the public or not.

The size information field 151e stores information specifying the data size of the send history file object corresponding to the entry in question. In the present embodiment, the size information field 151e stores the number of blocks.

The mapping information field 151f stores information specifying the location in the data storage part 152, at which the send history file object of the entry in question is stored. In the present embodiment, the mapping information field 151f stores block numbers of blocks in the data storage part 152.

Here, also in the present embodiment, the mapping information field 151f stores not only block numbers but also COW bits so that virtual copy of the send history file object can be realized as described later.

The data storage part 352 stores send history file objects.

The data management part 353 manages data stored in the map management information storage part 351 and the data storage part 352.

The IF part 154 is an interface for sending and receiving information through the IP network 180 and the storage network 181.

The above-described public storage 350 also can be implemented by a computer 290 as shown in FIG. 15.

For example, the map management information 351 and the data storage part 352 can be implemented by the external storage 291. The data management part can be implemented when prescribed programs stored in the external storage 291 are loaded into the memory 292 and executed by the CPU 293. The IF part 154 can be implemented by the communication unit 294.

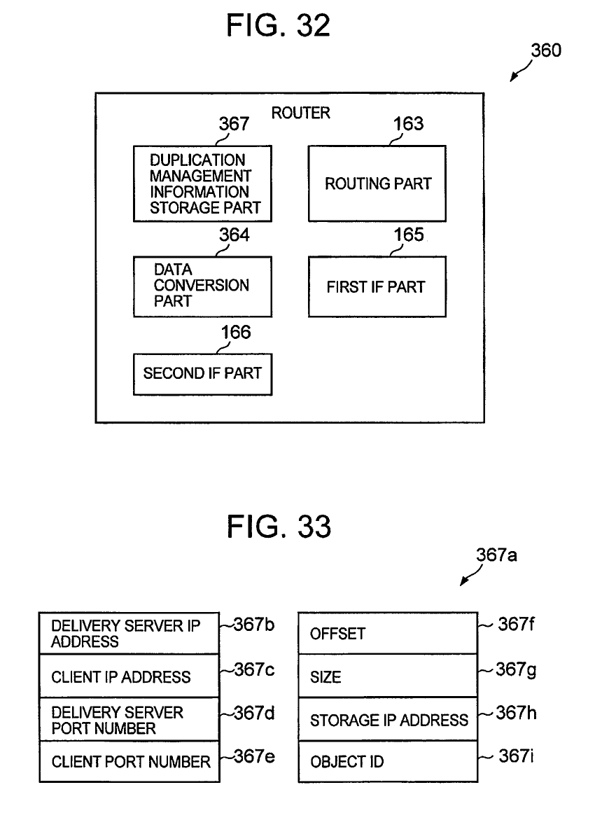

FIG. 32 is a schematic diagram showing the router 360.

As shown in the figure, the router 360 comprises a duplication management information storage part 367, a routing part 163, a data conversion part 364, a first IF part 165 and a second IF part 166.

The duplication management information storage part 367 stores information specifying which part of UDP data sent from the delivery server 310 is duplicated and which public storage 350 stores the duplicated part as a send history file object and what identification information identifies the send history file object, for each connection established between the delivery server 310 and the client terminal 170.

For example, in the present embodiment, the duplication management information storage part 367 stores a duplication management table 367a as shown in FIG. 33 (a schematic diagram showing the duplication management table 367a).

As shown in the figure, the duplication management table 367a has a delivery server IP address field 367b, a client IP address field 367c, a delivery server port number field 367d, a client port number field 367e, an offset field 367f, a size field 367g, a storage IP address field 367h and an object ID field 367i.

The delivery server IP address field 367b stores the IP address of the connected delivery server 310.

The client IP address field 367c stores the IP address of the connected client terminal 170.

The delivery server port number field 367d stores the port number of the connected delivery server 310.

The client port number field 367e stores the port number of the connected client terminal 170.

The offset field 367f stores information specifying a start position for generating a duplicate from UDP data sent from the delivery server 310.

The size field 367g stores information specifying the size measured from the start position for generating the duplicate from the UDP data sent from the delivery server 310.

Here, it is preferable that the part designated by the offset field 367f and the size field 367g include information that can uniquely identify the file object. For example, the part in question preferably includes an application protocol header or the like.

The storage IP address field 367h stores the IP address of the public storage 350 that stores the send history file object generated by taking the duplicate from the UDP data sent from the delivery server 310.

The object ID field 367i stores a send history object ID that is given to the send history file object generated by taking the duplicate from the UDP data sent from the delivery server 310.

The routing part 163 controls so-called routing for transferring packets received from the first IF part 165 or the second IF part 166.

The data conversion part 364 updates the duplication management table 367 on the basis of duplication management information received from the delivery server 310.

Further, the data conversion part 364 controls processing of generating a send history file object by duplicating a specific part of UDP data received from the delivery server 310, on the basis of the duplication management table 367a, and sending the generated send history file object to the public storage 350 through the second IF part 166.

The first IF part 165 and the second IF part 166 are interfaces for sending and receiving data through the IP network 180.

The router 360 also can be implemented by a computer 390 as shown in FIG. 16.

For example, the duplication management information storage part 367 can be implemented by the external storage 391. The routing part 163 and the data conversion part 364 can be implemented when prescribed programs stored in the external storage 391 are loaded into the memory 392 and executed by the CPU 393. The first IF part 165 can be implemented by the communication unit 394, and the second IF part 166 by the communication unit 395.

The client terminal 170 sends a connection request and a delivery request to the delivery server 110, to receive UDP data. A conventionally-used computer that can communicate through IP can be used as the client terminal 170, and its detailed description will be omitted.

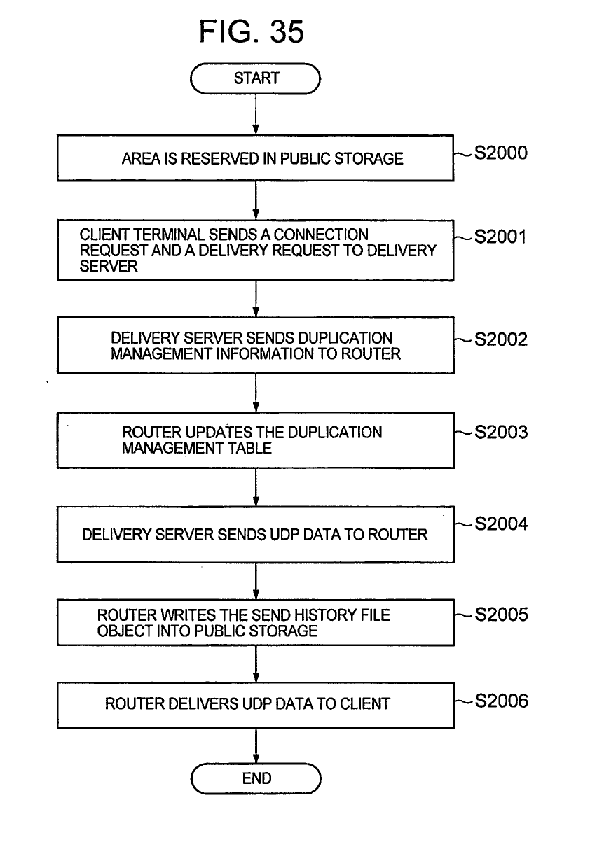

General processing in the delivery system 300 of the above-described configuration will be described referring to a flowchart shown in FIG. 35.

First, the send processing part 313 of the delivery server 310 issues a storage area assignment request to the domain server 340. The domain server 340 reserves a specific area in a specific public storage 350 by using the public storage management table 141a similarly to the first embodiment (S2000). At that time, the domain server 340 returns the IP address of the public storage 350 in which the specific area has been reserved, to the delivery server 310.

Next, the client terminal 170 sends a connection request and a delivery request to the delivery server 310 (S2001). When the delivery server 310 receives the connection request and the delivery request, the send processing part 313 sends duplication management information specifying which part of UDP data should be duplicated and which public storage 350 should store the duplicated part to the router 360 before sending the UDP (S2002).

When the router 360 receives the duplication management information, the data conversion part 364 updates the duplication management table 367a on the basis of the received duplication management information (S2003).

The delivery server 310 sends the UDP data for which the delivery request has been received to the router 360 (S2004).

When the router 360 receives the UDP data from the delivery server 310, the data conversion part 364 duplicates the specific part of the received UDP data according to the duplication management table 367a, and adds the current time information to the duplicated part to generate a send history file object. Then, the router 360 sends the send history file object to the public storage 350 (S2005).

The routing part 163 of the router 360 transfers the UDP data to the client terminal 170 (S2006).

Thus, when the send processing part 313 of the delivery server 310 sends an acquisition request designating the send history object ID and the IP address of the private storage 320 to the public storage 350, the send history file object stored in the public storage 350 is transferred from the public storage 350 to the private storage 320, and the delivery server 310 can take in the send history file object.

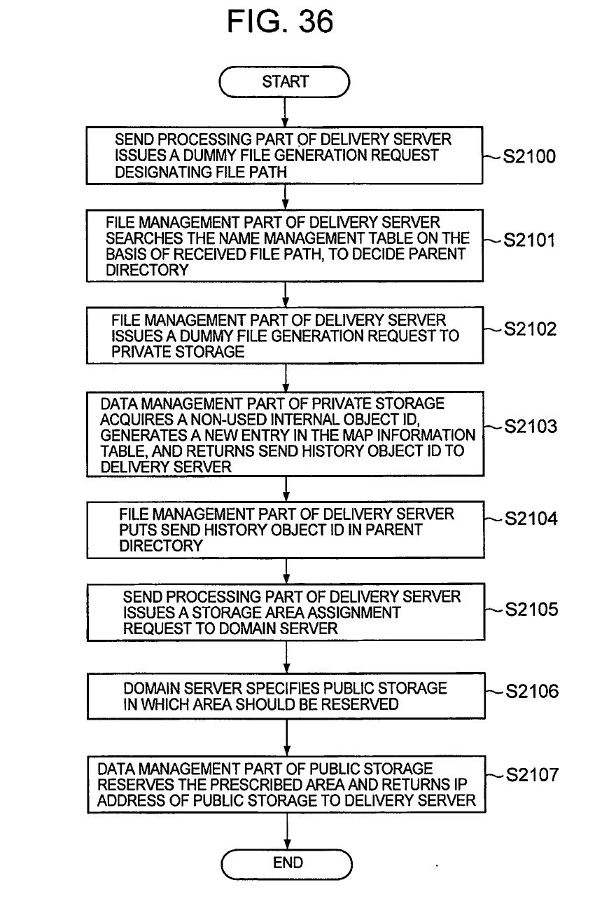

FIG. 36 is a flowchart showing processing of sending and receiving a storage area assignment request between the delivery server 310 and the domain server 340.

First, the send processing part 313 of the delivery server 110 issues a dummy file generation request designating a file path, to the file management part 314 (S2100).

Next, the file management part 314 divides the received file path into path elements and searches the name management table 111a stored in the name management information storage part 111 from the root directory 111b, to determine the address at which the parent directory to the file path in question exists (S2101).

Next, the file management part 314 issues a dummy file generation request to the private storage 320 (S2102).

Next, the data management part 323 of the private storage 320 searches the map management table 121a stored in the map management information storage part 321, to obtain a non-used internal object ID, to generate a new entry for a dummy file. The data conversion part 323 returns the send history object ID to the delivery server 310 (S2103).

Here, the object ID field 121b of the new entry generated in step S2103 stores a send history object ID that is obtained by coupling the IP address of the private storage itself and the reserved internal object ID. The public/non-public field 151d stores the public bit. The size information field 151e stores “0”. The mapping information field 151f stores no information.

Next, the file management part 314 puts the send history object ID returned in step S2103 and a file name of the dummy file of step S2100 in the parent directory obtained in step S2101 (S2104). Further, the file management part 314 puts the file attribute in the attribute field 111c and “0” in the size field 111e.

Next, the send processing part 313 issues a storage area assignment request to the domain server 340 (S2105). The storage assignment requests designates the IP address of the private storage 320, the send history object ID returned in step S2103 and the number of blocks to be reserved for storing the duplicate of the part of the UDP data. The number of blocks may be calculated based on the size of the UDP data and the ratio of the part to be duplicated.

Next, the domain management part 342 of the domain server 340 searches the public storage management table 141a to specify the entry whose free capacity field 141d stores the maximum value, and reserves an area in the public storage 350 corresponding to that entry (S2106). Then, the domain management part 342 stores information specifying the IP address of the private storage, the send history object ID and the number of blocks included in the storage area assignment request into the private storage ID address field 141e, the object ID field 141f and the number-of-blocks field 141g of the entry in question, respectively. Further, the domain management part 342 reduces the value of the free capacity field 141d by the reserved number of blocks.

Next, the domain management part 142 returns the IP address of the public storage in which the area has been reserved to the delivery server 110 through the IF part 143 (S2107).

The send processing part 313 of the delivery server 310 is activated at regular time intervals to issue storage area assignment continuation requests to the domain server 340 through the IF part 115. Each continuation request may store information similar to the information stored in the storage area assignment request sent in step S2105.

When the domain server 340 receives such a storage area assignment continuation request, the corresponding time-out value stored in the time-out field 141h of the public storage management table 141a is cleared to “0”.

On the other hand, the domain management part 342 of the domain server 340 is activated at regular time intervals to increment all the time-out values stored in the time-out field 141h of the public storage management table 141a, and forcedly frees the assignment of a storage area whose time-out value becomes a prescribed value or larger. In detail, the corresponding fields 141e-141h are freed, and the free capacity field 141d is increased by the registered number of blocks.

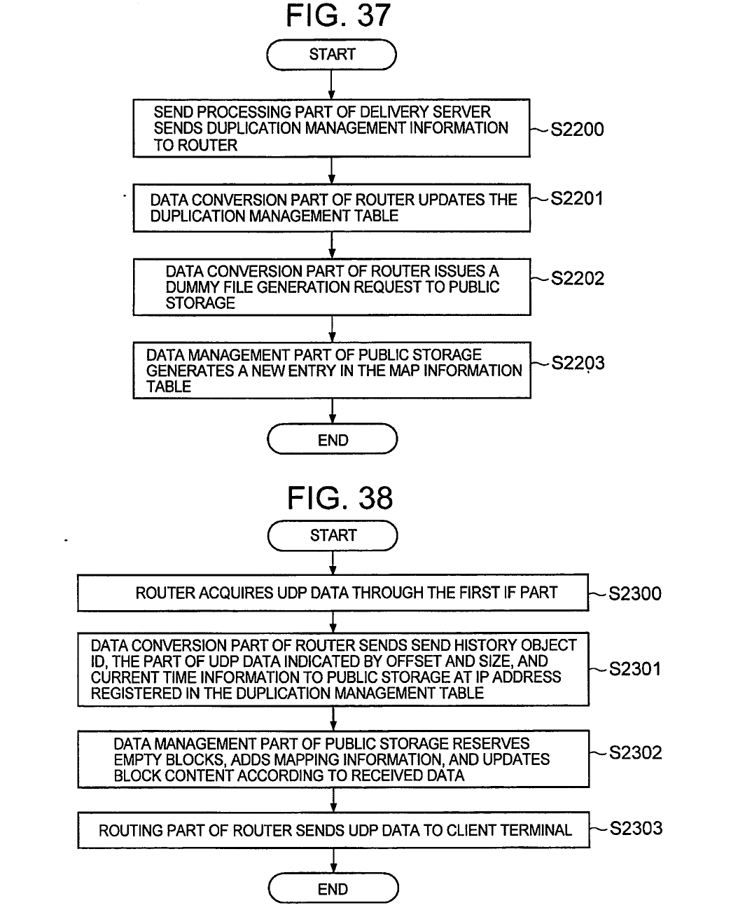

FIG. 37 is a flowchart showing processing of sending and receiving the duplication management information between the delivery server 310 and the router 360.

First, the send processing part 313 of the delivery server 310 sends the duplication management information 384 to the router 360 (S2200).

Here, the delivery server IP address storage area 384a, the client IP address storage area 384b, the delivery server port number storage area 384c and the client port number storage area 384d of the duplication management information 384 store the respective values stored in the connection request received from the client terminal 170. The offset storage area 384e and the size storage area 384f designate the previously-determined part of the UDP data, i.e. the part to be duplicated. The public storage IP address storage area 384g designates the IP address returned in step S2107 of FIG. 36. The object ID storage area 384h designates the send history object ID given in step S2104 of FIG. 36.

Next, the data conversion part 364 of the router 360 updates the duplication management table 367 stored in the duplication management information storage part 36 by the values stored in the duplication management information received in step S2200 (S2201).

The data conversion part 364 of the router 360 issues a dummy file generation request to the public storage 350 through the second IF part 166 (S2202). At that time, the send history object ID stored in the duplication management information received in step S2200 is designated in the dummy file generation request.

Next, the data conversion part 353 of the public storage 350 searches the map management table 151a stored in the map management information storage part 351, to obtain a non-used internal object ID for the dummy file requested in step S2202 and to generate a new entry (S2203).

Here, the object ID field 151b of the new entry stores the send history object ID designated in the dummy file generation request received in step S2202. The public/non-public bit field 151d stores the public bit. The size information field 151e stores “0”. The mapping information field 151f stores no information.

FIG. 38 is a flowchart showing processing of sending UDP data from the delivery server 310 to the client terminal 170 through the router 360.

First, the data conversion part 364 of the router 360 receives UDP data from the send processing part 313 of the delivery server 310 through the first IF part 165 (S2300).

Here, for example as shown in FIG. 34B, the UDP data has a delivery server IP address storage area 385a, a client IP address storage area 385b, a delivery server port number storage area 385c, a client port number storage area 385d, an AP header storage area 385e and a data storage area 385f.

The data conversion part 364 of the router 360 searches the duplication management table 367a corresponding to the IP address of the delivery server 310, the IP address of the client terminal 170, the port number of the delivery server 310 and the port number of the client terminal stored in the UDP data 385. Further, the data conversion part 364 writes a part (determined by the offset and the size information stored in the duplication management table 367a) of the received UDP data 385 and the current time information while designating the send history object ID, to the public storage 350 whose IP address is stored in the duplication management table 367a (S2301)

Next, the data management part 353 of the public storage 350 searches the map management table 151a stored in the map management information storage part 351, to specify the entry whose object ID field 151b stores the send history object ID received. Further, the public storage 350 reserves empty blocks based on the free block list field 151g, and registers the reserved blocks in the mapping information field 151f of the entry in question. Here, the COW bits of the mapping information field 151f are set to “0”, and the size information field 151e is incremented. The part of UDP data and the current time information received in step S2301 are written into the blocks in question (S2302).

The routing part 163 of the router 360 sends the UDP data received in step S2300 to the client terminal 170 through the second IF part 166 (S2303).

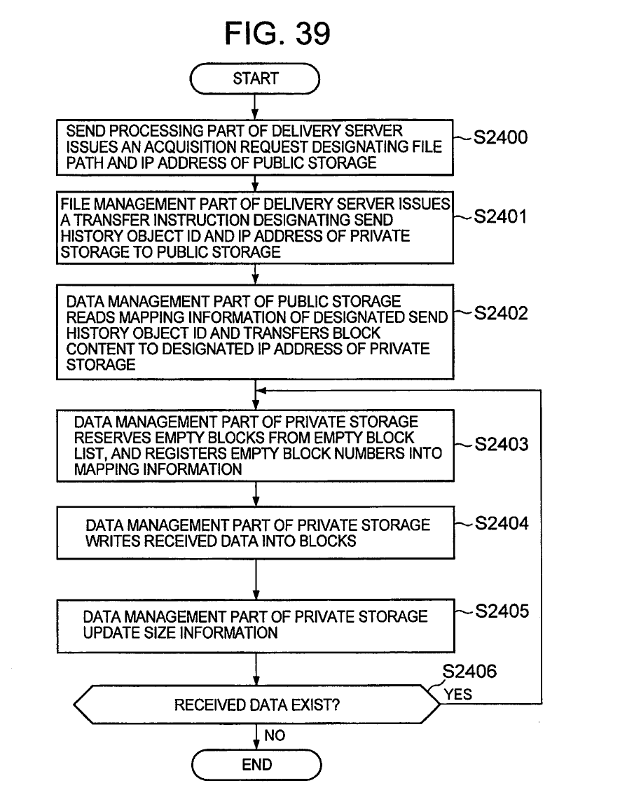

FIG. 39 is a flowchart showing processing in which the delivery server 310 obtains a send history file object from the public storage 350.

First, the send processing part 313 of the delivery server 310 issues a file object acquisition request to the file management part 314 (S2400). At that time, the send processing part 313 designates the file path designated in step S2100 of FIG. 36 and the public storage's IP address received in step S2107.

Next, the file management part 314 of the delivery server 310 divides the received file path into path elements, searches the name management table 111a stored in the name management information storage part 111 from the root directory 111b, to obtain the send history object ID corresponding to the file path from the parent directory stored in step S2104 of FIG. 36. Further, the file management part 314 issues a file object acquisition instruction to the public storage 350 (S2401). The send history object ID acquired above and the IP address of the private storage 320 are designated in the file object acquisition instruction.

Next, the data management part 353 of the public storage 350 searches the map management table 151a stored in the map management information storage part 351, to retrieve the entry whose object ID field 151b stores the send history object ID designated in the file object acquisition request. Then, from the mapping information field 151f of the retrieved entry, the data management part 353 specifies the block numbers at which the file object is stored. Then, the data management part 353 transfers the content of the specified blocks together with the send history object ID designated in the file object acquisition request to the IP address of the private storage 320 designated in the file object acquisition request (S2402).

Next, the data management part 323 of the private storage 320 searches the map management table 121a stored in the map management information storage part 321, to specify the entry whose object ID field 121b stores the send history object ID received in step S2402. Further, the data management part 323 reserves empty blocks from the free block list field 121g, and registers the block numbers of the reserved empty blocks into the mapping information field 121f of the entry in question (S2403).

Next, the data management part 323 of the private storage 320 writes the data received in step S2402 into the blocks reserved in step S2403 (S2404).

Next, the data management part 323 of the private storage 320 increments the number of blocks stored in the size information field 121e of the entry specified in step S2403 (S2405).

Next, the data management part 323 of the private storage 320 examines whether all the data received in step S2402 have been written into the blocks reserved in step S2403 (S2406). If all the data have been written, the processing is ended. Otherwise, the processing of steps S2403-S2405 is performed again.

By transferring the send history file object stored in the public storage 350 to the private storage 320 according to the above-described processing, the operator of the delivery server 310 becomes able to confirm the send history file object.

By confirming the file object when the UDP data sent from the delivery server 310 do not arrive at the client terminal 170, it becomes possible to judge whether the cause lies in the communication path between the delivery server 310 and the router 360 or in the communication path between the router 360 and the client terminal 170.

In the above-described embodiment, a send history file object accumulated in the public storage 350 is transferred to the private storage 320. This mode is not restrictive. For example, also the present embodiment can employ the configuration of the delivery system 200 as shown in FIG. 26. In that case, when a send history file object accumulated in the public storage 250 is transferred to the delivery server 210 through the IP network 180, and stored in the external storage of the delivery server 210, the same effect is produced as in the above-described delivery system 300.

Further, in the above-described embodiment, file objects are accumulated in the public storage 350 through the router 360. This mode is not restrictive. For example, a communication apparatus (a server) having a similar configuration to the configuration of the router 360 may be arranged in the IP network 180 so that send history file objects are accumulated in the public storage 350 through the communication apparatus.

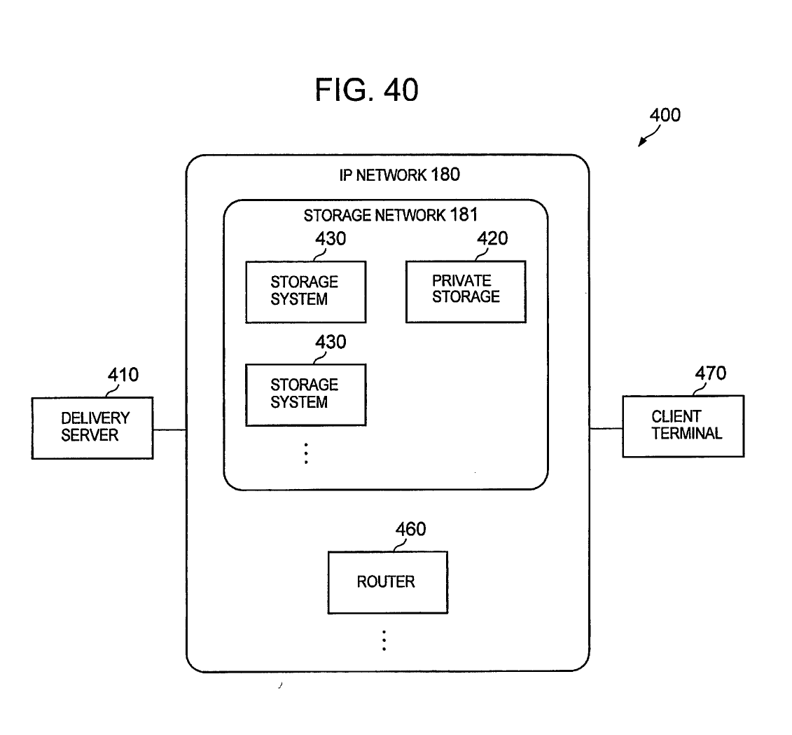

FIG. 40 is a schematic block diagram showing a delivery system 400 as a third embodiment of the present invention.

As shown in the figure, the delivery system 400 comprises a delivery server 410, a private storage 420, storage systems 430, a router 460 and a client terminal 470.

The delivery server 410 and the client terminal 470 can communicate with each other through an IP network 180, and the router 460 is arranged in the IP network 180.

Further, a storage network 181 is provided in the IP network 180. The private storage 420 and the storage systems 430, which are provided in the storage network 181, can communicate with one another within the storage network 181. Further, these private storage 420 and storage systems 430 can communicate with the delivery server 410, the router 460 and the client terminal 470 through the IP network 180.

In the present embodiment, the delivery server 410 sends data according to UDP to the client terminal 470. The router 460 stores UDP data sent in this way into a public storage 450 connected within a storage system 430. The client terminal 470 can obtain the UDP data stored in the public storage 450 after the UDP data are transferred to the private storage 420 through the storage network 181. As a result, even when a failure occurs in the IP network 180 between the router 460 and the client terminal 470, the client terminal 470 can certainly obtain the UDP data.

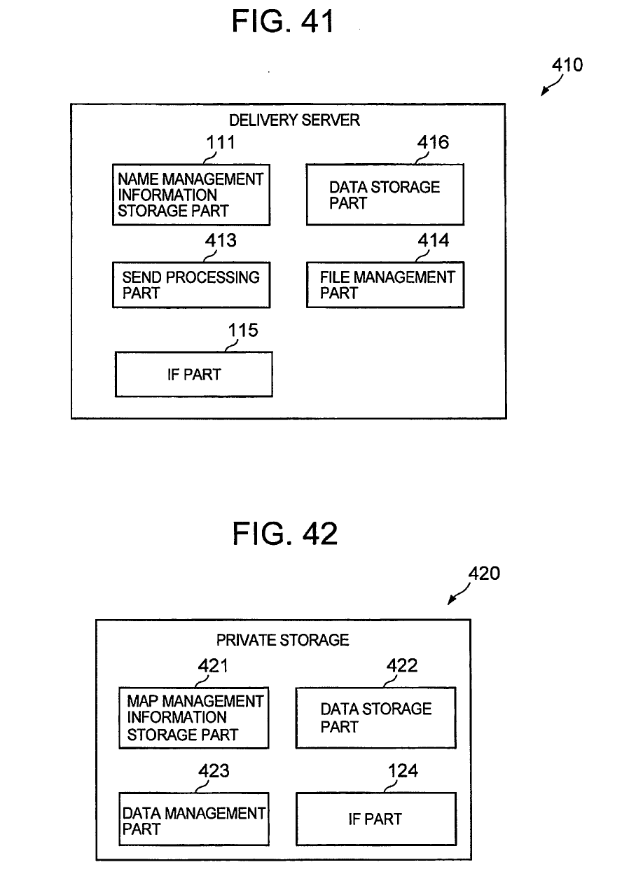

FIG. 41 is a schematic diagram showing the delivery server 410.

As shown in the figure, the delivery server 410 comprises a name management information storage part 111, a send processing part 413, a file management part 414, an IF part 115 and a data storage part 416.

The name management information storage part 111 stores information that specifies: a path name; and information (an object ID) identifying a file object corresponding to that path name. Similarly to the first embodiment, the name management information storage part 111 stores a name management table 111a as shown in FIG. 3, for example.

The send processing part 413 controls processing of delivering a file object stored in the data storage part 416, in response to a connection request and a delivery request from the client terminal 470. Here, the file object is delivered as UDP data.

For example, UDP data 385 as shown in FIG. 34B may be sent to the client terminal 470.

The file management part 414 manages information stored in the name management information storage part 111 and the data storage part 416.

The IF part 115 is an interface for sending and receiving information through the IP network 180.

The data storage part 416 stores a file object to be sent to the client terminal 470.

The delivery server 410 also can be implemented by a computer 190 as shown in FIG. 14.

For example, the name management information storage part 111 and the data storage part 416 can be implemented by the external storage 191. The send processing part 413 and the file management part 414 can be implemented when prescribed programs stored in the external storage 191 are loaded into the memory 192 and executed by the CPU 193. The IF part 115 can be implemented by the communication unit 196.

FIG. 42 is a schematic diagram showing the private storage 420.

As shown in the figure, the private storage 420 comprises a map management information storage part 421, a data storage part 422, a data management part 423 and an IF part 124.

The map management information storage part 421 stores at least identification information for identifying a file object and information indicating the storage location of the file object, for each file object corresponding to UDP data stored in the data storage part 422.

For example, in the present embodiment also, the map management information storage part 421 stores a map management table 121a as shown in FIG. 6. However, data stored in the map management table 121a are different from data in the first embodiment.

As shown in the figure, the map management table 121a has an object ID field 121b, an internal object ID field 121c, a public/non-public bit field 121d, a size information field 121e, a mapping information field 121f and an free block list field 121g.

The object ID field 121b stores identification information (an object ID) for identifying a file object of UDP data corresponding to the entry in question.

Here, in the present embodiment, an object ID added to UDP data sent from the public storage 450 is used.

The internal object ID field 121c stores information for identifying the file object corresponding to the entry in question. Each time when a new file to be stored in the data storage part 422 of the private storage 420 is generated, the data management part 323 generates identification information (ID) of the newly-generated file and stores the generated ID in the internal object ID field 121c.

The public/non-public bit field 121d stores information specifying whether the file object of the entry in question is opened to the public or not.

The size information field 121e stores information specifying the data size of the file object of the entry in question. In the present embodiment, the size information field 121e stores the number of blocks.

The mapping information field 121f stores information specifying the location in the data storage part 422, at which the file object of the entry in question is stored. In the present embodiment, the mapping information field 121f stores block numbers of blocks in the data storage part 422.

In the present embodiment, the mapping information field 121f stores not only block numbers but also COW bits so that virtual copy of the file object can be realized.

The data storage part 422 stores a file object transferred from the public storage 450.

The data management part 423 manages data stored in the map management information storage part 421 and the data storage part 422.

The IF part 124 is an interface for sending and receiving information through the IP network 180 and the storage network 181.

The above-described private storage 420 also can be implemented by a computer 290 as shown in FIG. 15.

For example, the map management information storage part 421 and the data storage part 422 can be implemented by the external storage 291. The data management part 423 can be implemented when prescribed programs stored in the external storage 291 are loaded into the memory 292 and executed by the CPU 293. The IF part 124 can be implemented by the communication unit 294.

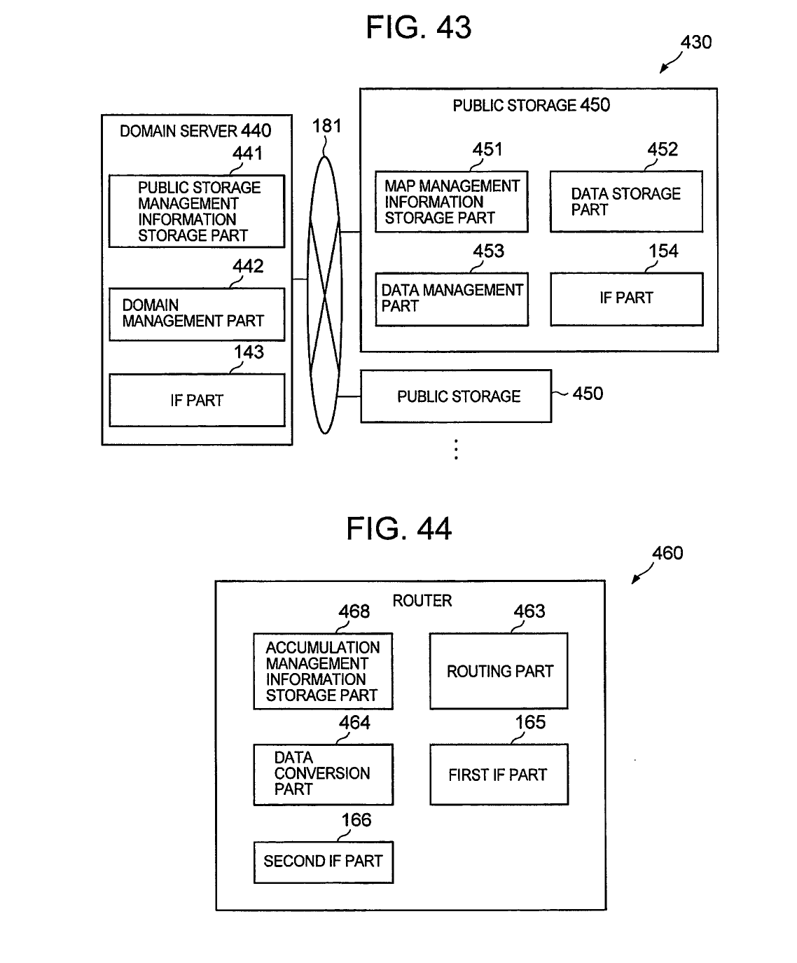

FIG. 43 is a schematic diagram showing a storage system 430.

As shown in the figure, a storage system 430 comprises a domain server 440 and one or more public storages 450. The domain server 440 and the public storages 450 can send and receive information to and from one another through the storage network 181.

The domain server 440 comprises a public storage management information storage part 441, a domain management part 442 and an IF part 143.

The public storage management information storage part 441 stores information specifying file objects stored in the public storages 450 managed by the domain server 440.

For example, in the present embodiment also, the public storage management information storage part 341 stores a public storage management table 141a as shown in FIG. 8. However, data stored in the public storage management table 141a are different from data in the first embodiment.

As shown in the figure, the public storage management table 141a has a public storage IP address field 141b, a total capacity field 141c, a free capacity field 141d, a private storage IP address field 141e, an object ID field 141f, a number-of-blocks field 141g and a time-out field 141h for each public storage 450.

The public storage IP address field 141b stores the IP address of a public storage 450 managed by the domain server 440.

The total capacity field 141c stores the total storage capacity assigned for storing file objects in the public storage 450 specified in the public storage IP address field 141b.

The free capacity field 141d stores a free capacity out of the total storage capacity assigned for storing file objects in the public storage 450 specified in the public storage IP address field 141b.

The private storage IP address field 141e stores the IP address of a private storage 420 as a destination of sending a file object stored in the public storage 450 specified in the public storage IP address field 141b.

The object ID field 141f stores identification information for specifying a file object stored in the public storage 450 specified in the public storage IP address field 141b.

In the present embodiment, the object ID field 141f stores an object ID included in a write request from the router 460.

The number-of-blocks field 141g stores the number of blocks assigned for storing a file object in the public storage 450 specified in the public storage IP address field 141b.

The time-out field 141h stores a time-out value for reservation of an area assigned for storing a file object in the public storage 450 specified in the public storage IP address field 141b. By managing such a time-out value, it is possible to free the area in question forcedly when an assignment continuation request for the area does not arrive from the client terminal 470 within prescribed time (for example, owing to failure of the client terminal 470).

The domain management part 442 controls general processing in the domain server 440. In particular, in the present embodiment, the domain management part 442 manages information stored in the public storage management information storage part 441.

The IF part 143 is an interface for sending and receiving information through the IP network 180 and the storage network 181.

The domain server 440 also can be implemented by a computer 190 as shown in FIG. 14.

For example, the public storage management information storage part 441 can be implemented by the external storage 191. The domain management part 442 can be implemented when prescribed programs stored in the external storage 191 are loaded into the memory 192 and executed by the CPU 193. The IF part 143 can be implemented by the communication unit 196.

Returning to FIG. 43, each public storage 450 comprises a map management information storage part 451, a data storage part 452, a data management part 453 and an IF part 154.

The map management information storage part 451 stores at least identification information for identifying a file object and information indicating the storage location of the file object, for each file object stored in the data storage part 452.

For example, in the present embodiment, the map management information storage part 451 stores a map management table 151a as shown in FIG. 9, similarly to the first embodiment. However, data stored in the map management table 151a are different from data in the first embodiment.

As shown in the figure, the map management table 151a has an object ID field 151b, an internal object ID field 151c, a public/non-public bit field 151d, a size information field 151e, a mapping information field 151f and an free block list field 151g.

The object ID field 151b stores information for identifying a file object corresponding to the entry in question.

In the present embodiment, the object ID field 151b stores an object ID for identifying a file object (UDP data) sent from the router 460.

The internal object ID field 151c stores information for identifying a send history file object corresponding to the entry in question.

The public/non-public bit field 151d stores information specifying whether the send history file object corresponding to the entry in question is open to the public or not.

The size information field 151e stores information specifying the data size of the send history file object corresponding to the entry in question. In the present embodiment, the size information field 151e stores the number of blocks.

The mapping information field 151f stores information specifying the location in the data storage part 152, at which the send history file object of the entry in question is stored. In the present embodiment, the mapping information field 151e stores block numbers of blocks in the data storage part 452.

In the present embodiment, the mapping information field 151f stores not only block numbers but also COW bits so that virtual copy of the send history file object can be realized as described later.

The data storage part 452 stores a file object corresponding to UDP data sent from the router 460.

The data management part 453 manages data stored in the map management information storage part 451 and the data storage part 452.

The IF part 154 is an interface for sending and receiving information through the IP network 180 and the storage network 181.

The above-described public storage 450 also can be implemented by a computer 290 as shown in FIG. 15.

For example, the map management information storage part 451 and the data storage part 452 can be implemented by the external storage 291. The data management part 453 can be implemented when prescribed programs stored in the external storage 291 are loaded into the memory 292 and executed by the CPU 293. The IF part 154 can be implemented by the communication unit 294.

FIG. 44 is a schematic diagram showing the router 460.

As shown in the figure, the router 460 comprises an accumulation management information storage part 468, a routing part 463, a data conversion part 464, a first IF part 165 and a second IF part 166.

The accumulation management information storage part 468 stores information specifying which public storage 450 stores, as a file object, UDP data sent from the delivery server 410 and what identification information identifies the file object, for each connection established between the delivery server 410 and the client terminal 470.

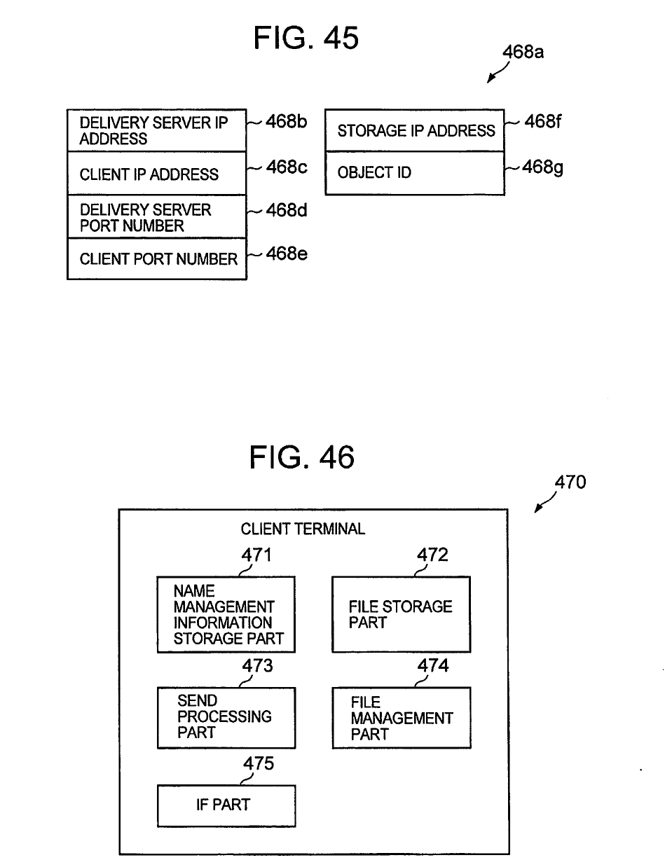

For example, in the present embodiment, the accumulation management information storage part 468 stores an accumulation management table 468a as shown in FIG. 45 (a schematic diagram showing the accumulation management table 468).

As shown in the figure, the accumulation management table 468a has a delivery server IP address field 468b, a client IP address field 468c, a delivery server port number field 468d, a client port number field 468e, a storage IP address field 468f and an object ID field 468g.

The delivery server IP address field 468b stores the IP address of the connected delivery server 410.

The client IP address field 468c stores the IP address of the connected client terminal 470.

The delivery server port number field 468d stores the port number of the connected delivery server 410.

The client port number field 468e stores the port number of the connected client terminal 470.

The storage IP address field 468f stores the IP address of the public storage 450 that stores, as a file object, UDP data sent from the delivery server 410.

The object ID field 468g stores the object ID of the UDP data sent from the delivery server 410.

The routing part 463 controls so-called routing for transferring packets received from the first IF part 165 or the second IF part 166.

In the present embodiment, UDP data sent from the delivery server 410 are transferred not to the client terminal 470 but to the public storage 450.

The data conversion part 464 updates the accumulation management table 468a on the basis of accumulation management information received from the client terminal 470.

Further, the data conversion part 464 controls processing of generating a file object from the UDP data received from the delivery server 410 on the basis of the accumulation management table 468a and sending the generated file object to the public storage 450 through the routing part 463 and the second IF part 166.

The first IF part 165 and the second IF part 166 are interfaces for sending and receiving data through the IP network 180.

The router 460 also can be implemented by a computer 390 as shown in FIG. 16.

For example, the accumulation management information storage part 468 can be implemented by the external storage 391. The routing part 463 and the data conversion part 464 can be implemented when prescribed programs stored in the external storage 391 are loaded into the memory 392 and executed by the CPU 393. The first IF part 165 can be executed by the communication unit 394, and the second IF part 166 by the communication unit 395.

FIG. 46 is a schematic diagram showing the client terminal 470.

As shown in the figure, the client terminal 470 comprises a name management information storage part 471, a file storage part 472, a send processing part 473, a file management part 474 and an IF part 475.

The name management information storage part 471 stores information that specifies: a path name; and information (an object ID) for identifying a file object corresponding to the path name. For example, the name management information storage part 471 stores a name management table 111a as shown in FIG. 3.

The file storage part 472 stores a file object transferred from the private storage 420.

The send processing part 473 controls processing of sending a connection request and a delivery request to the delivery server 410.

The send processing part 473 controls processing of issuing a storage area assignment request to the domain server 440.

Further, the send processing part 473 controls processing of sending accumulation management information specifying which public storage 450 should store what file ID identifying UDP data sent from the delivery server 410 to the router 460 before sending a connection request and a delivery request to the delivery server.

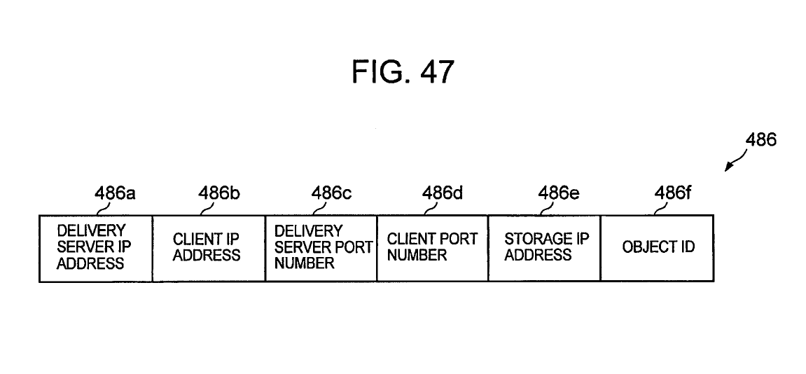

Here, for example, the send processing part 473 sends to The router 460 duplication management information 486 as shown in FIG. 47 (a schematic diagram showing duplication management information 486).

As shown in the figure, duplication management information 486 has a delivery server IP address storage area 486a, a client IP address storage area 486b, a delivery server port number storage area 486c, a client port number storage area 486d, a storage IP address storage area 486e and an object ID storage area 486f. Information to be stored in these areas will be described later.

Further, the send processing part 473 controls processing of sending an acquisition request designating an object ID and the IP address of the private storage 420 to the public storage 450, and transferring the object specified by the object ID from the public storage 350 to the private storage 320 so that the client terminal 470 takes in the object.

The file management part 414 manages information stored in the name management information storage part 471 and the file storage part 475.

The IF part 475 is an interface for sending and receiving information through the IP network 180.

The client terminal 470 also can be implemented by a computer 190 as shown in FIG. 14.

For example, the name management information storage part 471 and the file storage part 472 can be implemented by the external storage 191. The send processing part 473 and the file management part 474 can be implemented when prescribed programs stored in the external storage 191 are loaded into the memory 192 and executed by the CPU 193. The IF part 475 can be implemented by the communication unit 196.

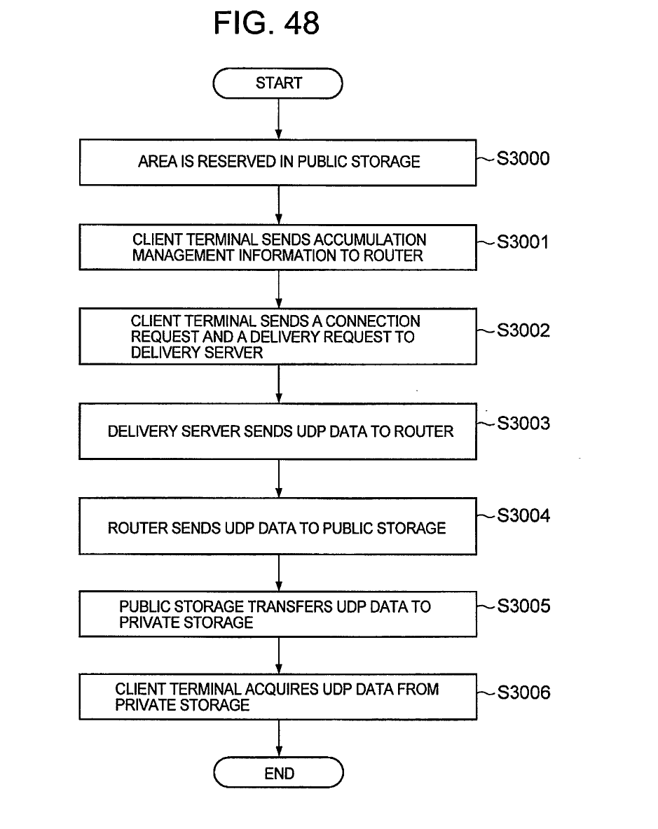

General processing flow in the delivery system 400 of the above-described configuration will be described referring to the flowchart shown in FIG. 48.

First, the send processing part 473 of the client terminal 470 issues a storage area assignment request to the domain server 440. Similarly to the first embodiment, the domain management part 442 of the domain server 440 reserves a specific area in a specific public storage 450 by using the public storage management table 141a (S3000). At that time, the domain management part 442 of the domain server 440 returns the IP address of the public storage 450 in which the specific area has been reserved to the delivery server 310.

Next, the send processing part 473 of the client terminal 470 sends accumulation management information to the router 460 (S3001). The accumulation management information includes the IP address of the public storage 450 and an object ID. When the router 460 receives the accumulation management information, the data conversion part 464 updates the accumulation management table 468a stored in the accumulation management information storage part 468.

Next, the send processing part 473 of the client terminal 470 sends a connection request and a delivery request to the delivery server 410 (S3002). When the delivery server 410 receives the connection request and the delivery request, the send processing part 413 sends the UDP data (S3003).

When the router 460 receives the UDP data, the data conversion part 464 writes the received UDP data to the public storage 450 on the basis of the accumulation management table 468a (S3004).

Next, the send processing part 473 of the client terminal 470 sends a file object acquisition request to the public storage 450, so that the file object is transferred to the private storage 420 (S3005).

Next, the send processing part 473 of the client terminal 470 acquires the file object from the private storage (S3006).

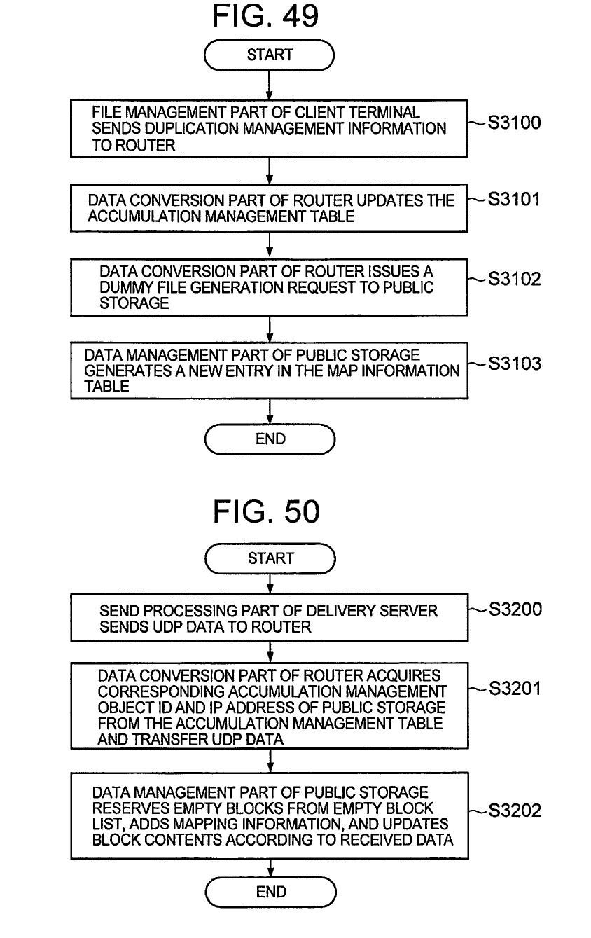

FIG. 49 is a flowchart showing processing of sending accumulation management information from the client terminal 470 to the router 460.

First, the send processing part 473 of the client terminal 470 sends accumulation management information to the router 460 through the IF part 475 (S3100).

Here, in the accumulation management information 486 as shown in FIG. 47, the delivery server IP address storage area 486a stores the IP address of the delivery server 410, the client IP address storage area 486b the IP address of the client terminal 470, the delivery server port number storage area 486c the port number of the delivery server 410, the client port number storage area 486d the port number of the client terminal 470, the storage IP address storage area 486e the IP address of the public storage 450 reserved in step S3000 of FIG. 48, and the object ID storage area 486f the object ID acquired from the private storage 420. According to a method similar to the method of the second embodiment in which a dummy file generation request is issued to the public storage, the object ID returned from the private storage 420 may be used as the object ID.

Next, the data conversion part 464 of the router 460 updates the accumulation management table 468a stored in the accumulation management information storage part 468 on the basis of the received accumulation management information (S3101). In this update, values in the accumulation management information are stored in the respective fields of the accumulation management table 468a.

Next, the data conversion part 464 of the router 460 issues a dummy file generation request including the object ID designated in the accumulation management information to the public storage 450 whose IP address is specified in the accumulation management information (S3102).

When the public storage 450 receives the dummy file generation request, the data management part 453 searches the map management table 151a stored in the map management information storage part 451, to obtain a non-used inner object ID, and generates a new entry for a dummy file (S3103).

Here, the object ID included in the dummy file generation request is stored in the object ID field 151b of the newly-generated entry in step 3103. The public bit is stored in the public/non-public bit field 151b. The size information field 151e is set to “0”. The mapping information field 151f stores no information.

FIG. 50 is a flowchart showing processing of sending UDP data from the delivery server 410 to the client terminal 470.

First, when the delivery server 410 receives a connection request and a delivery request from the client terminal 470, the send processing part 413 sends, as UDP data, the file object stored in the data storage part 416 to the router 460 (S3200). Here, the UDP data to be sent has a similar structure to the structure of UDP data 385 in the second embodiment (See FIG. 34B).

Next, when the router 460 receives the UDP data, the data conversion part 464 searches the accumulation management table 468a according to the IP address of the delivery server 410, the IP address of the client terminal 470, the port number of the delivery server 410 and the port number of the client terminal 470 stored in the received UDP data, to specify the object ID stored in the table, and transfers the received UDP data to the public storage 450 (S3201).

When the public storage 450 receives the UDP data, the data management part 453 searches the map management information table 451a to specify the entry whose object ID field 151b stores the object ID included in the received UDP data, and updates the entry in question (S3202). Here, in this update, empty blocks are reserved on the basis of the free block list field 151g, the reserved blocks are registered in the mapping information field 151f of the entry, the COW bits are set to “0”, and the value of the size information field 151e is incremented. Then, the data management part 453 writes the received UDP data to the reserved empty blocks.

According to the above-described configuration of the present embodiment, even if a large fluctuation in transmission delay occurs, the public storage 450 can perform buffering. Thus, large-volume data can be received from the delivery server 410 without causing buffer overflow on the side of the client terminal 470.

In the above-described embodiment, a file object accumulated in the public storage 450 is transferred to the private storage 420. This mode is not restrictive. For example, in the present embodiment also, it is possible to arrange the delivery system as the delivery system 200 as shown in FIG. 26. In such a case, a file object accumulated in the public storage 250 is transferred to the client terminal 170 through the IP network 180, and stored in the external storage of the client terminal 170. A similar effect to that of the above-described delivery system 400 can be produced. In such cases, instead of the public storage 250, private storage used exclusively by the client terminal 170 may accumulate file objects.

In the above-described embodiment, a file object (UDP data) is stored in the public storage 450 through the router 460. This mode is not restrictive. For example, a communication apparatus (a server) having a similar configuration to the router 460 may be arranged in the IP network 180 in order to accumulate file objects (UDP data) in the public storage 450.

In the above-described embodiments, the storage network 181 is constructed using IP. This mode is not restrictive. For example, Fibre Channel Protocol (FCP), Small Computer System Interface (SCSI) protocol, Internet Small Computer System Interface (iSCSI) protocol, or the like may be used. In such cases, an apparatus such as a gateway may be provided between the storage network 181 and the IP network 180 for converting protocol.

1. A delivery system for delivering content data to a client terminal through a network, wherein:
the delivery system comprises a delivery server, a storage apparatus and a communication apparatus; and
the communication apparatus receives header information specific to the content data from the delivery server, receives a data body of the content data from the storage apparatus, couples the header information with the data body of the content data, and sends the couple to the client terminal.

2. A delivery system of claim 1, wherein:
the delivery server comprises:
a storage part that stores identification information identifying the data body of the content data stored in the storage apparatus and address information of the storage apparatus storing the data body identified by the identification information; and
a control part that controls processing of sending communication data in which the header information, the identification information and the address information are stored.

3. A delivery system of claim 2, wherein:
the storage apparatus comprises:
a storage part that stores the content data in association with the identification information; and
a control part that controls processing of returning the data body corresponding to the identification information to a sender of a request designating the identification information, in response to the request.

4. A delivery system of claim 3, wherein:
the communication apparatus comprises a control part that controls:
processing of sending a request designating identification information included in the communication data received from the delivery server, to the storage apparatus specified by the address information included in the communication data; and
processing of coupling the data body received from the storage apparatus with the header information included in the communication data, and sending the couple to the client terminal.

5. A communication apparatus in a delivery system that comprises a delivery server, a storage apparatus and a client terminal, and that delivers content data to the client terminal through a network, wherein:
the communication apparatus receives header information specific to the content data from the delivery server, receives a data body of the content data from the storage apparatus, couples the header information with the data body of the content data, and sends the couple to the client terminal.

6. A communication apparatus of claim 5, wherein the communication apparatus comprises a control part that controls:
processing of sending a request specifying identification information designated by the delivery server to the storage apparatus specified by address information designated by the delivery server; and
processing of coupling the data body received from the storage apparatus with the header information, and sending the couple to the client terminal.

7. A delivery system for delivering content data from a delivery server to a client terminal through a network, wherein:
the delivery system comprises a storage apparatus and a communication apparatus;
the communication apparatus generates a duplicate of a part of the content data received from the delivery server and sends the duplicate to the storage apparatus; and
the storage apparatus stores the duplicate received from the communication apparatus.

8. A delivery system of claim 7, wherein:
the delivery server comprises a control part that sends duplication management information to the communication apparatus before sending content data to the client terminal, with the duplicate management information storing information that specifies a part whose duplicate is to be generated out of the content data in the communication apparatus and identification information that identifies the duplicate.

9. A delivery system of claim 8, wherein the communication apparatus comprises a control part that controls processing of:
acquiring the duplicate of the part designated by the duplication management information, from the content data; and
sending the duplicate together with the identification information designated by the duplication management information, to the storage apparatus; and
the storage apparatus comprises a storage part that stores the duplicate received together with the identification information, together with the duplicate received from the communication apparatus.

10. A delivery system of claim 9, wherein the delivery server can acquire the duplicate from the storage apparatus by sending an acquisition request designating the identification information, to the storage apparatus.

11. A communication apparatus in a delivery system that comprises a delivery server, a storage apparatus and a client terminal and delivers content data from the delivery server to the client terminal through a network, wherein:
the communication apparatus generates a duplicate of a part of the content data received from the delivery server, and sends the duplicate to the storage apparatus so that the storage apparatus stores the duplicate.

12. A delivery system for delivering content data from a delivery server to a client terminal through a network, wherein:
the delivery system comprises a storage apparatus and a communication apparatus;
the communication apparatus sends content data sent from the delivery server to the storage apparatus; and
the client terminal can receive the content data from the storage apparatus.

13. A delivery system of claim 12, wherein:
the client terminal comprises a control part that sends accumulation management information to the communication apparatus, with the accumulation management information storing information that specifies address information of a storage apparatus to which the communication apparatus sends the content data; and
the communication apparatus sends the content data to the storage apparatus specified by the address information.

14. A delivery system of claim 13, wherein:
the accumulation management information stores identification information for identifying the content data;
the communication apparatus sends the content data and the identification information to the storage apparatus; and
the storage apparatus stores the content data received from the communication apparatus, in association with the identification information.

15. A delivery system of claim 14, wherein:
the client terminal can acquire the content data corresponding to the identification information by sending an acquisition request designating the identification information, to the storage apparatus.

16. A delivery method in a delivery system that comprises a delivery server, a storage apparatus, a communication apparatus and a client terminal, and that delivers content data to the client terminal through a network, the delivery method comprising:
a step in which the communication apparatus receives header information specific to the content data from the delivery server;
a step in which the communication apparatus receives a data body of the content data from the storage apparatus; and
a step in which the communication apparatus couples the header information with the data body and sends the couple to the client terminal.

17. A delivery method in a delivery system that comprises a delivery server, a storage apparatus, a communication apparatus and a client terminal, and that delivers content data to the client terminal through a network, the delivery method comprising:
a step in which the communication apparatus generates a duplicate of a part of the content data received from the delivery server;
a step in which the communication apparatus sends the duplicate to the storage apparatus;
a step in which the storage apparatus receives the duplicate; and
a step in which the storage apparatus stores the duplicate.

18. A delivery method in a delivery system that comprises a delivery server, a storage apparatus, a communication apparatus and a client terminal, and that delivers content data to the client terminal through a network, the delivery method comprising:
a step in which the communication apparatus receives content data sent from the delivery apparatus;
a step in which the communication apparatus sends the content data to the storage apparatus; and
a step in which the client terminal receives the content data from the storage apparatus.
